(19) United States
(12) Patent Application Publication
(10) Pub. No.: US 2006/0171440 A1
(43) Pub. Date: Aug. 3, 2006

(54) Apparatus for generating improved laser beam

(75) Inventors: Nikolai Ledentsov, Berlin (DE); Vitaly Shchukin, Berlin (DE)

Correspondence Address: Martin Moynihan;PRTSI Inc, P O BOx 16446, Arlington, VA, 22215, US

(73) Assignee: PBC Lasers Ltd., Tel-Aviv (IL)

(21) Appl. No.: 10/548,373

(22) PCT Filed: Mar. 14, 2004
(86) PCT No.: PCT/IL04/00242

§ 371 Date: Sep. 7, 2005

Related U.S. Application Data
(60) Provisional application No. 60/454,361, filed on Mar. 14, 2003.

(51) Int. Cl. H01S 3/08

(52) U.S. Cl. 372/99

(57) ABSTRACT

A selective reflector, for selectively preventing reflection of light passing therethrough. The selective reflector comprising at least one layer characterized by an angle-dependent reflectivity function. The angle-dependent reflectivity function being decreasing upon at least one interval of increasing impinging angle of the light on a surface of the at least one layer, such that when said impinging angle is within a predetermined range, the reflection of light is substantially prevented.

### FIELD AND BACKGROUND OF THE INVENTION

The present invention relates to improved laser radiation and, more particularly, to a selective reflector and an apparatus for providing a laser radiation characterized by a single or few modes and low beam divergence.

Semiconductor lasers play an important role in optical fiber transmission and signal amplification systems, wavelength division multiplexing transmission systems, wavelength division switching systems and wavelength cross-connection systems, as well as in the field of optical measurements, material processing, optical storage, sensing, and in other fields.

A semiconductor laser (first proposed in 1959) is based on current injection of non-equilibrium carriers into a semiconductor active medium, resulting in population inversion and sufficient modal gain to achieve lasing.

Referring now to the drawings, there are basically two types of semiconductor lasers which presently dominate the laser market, which are depicted in FIGS. 1a-b. FIG. 1a depicts a Vertical Cavity Surface-Emitting Laser (VCSEL), where the photons arc cycled in a high finesse cavity in vertical direction (upward in FIG. 1a). In this laser, the cavity is very short and the gain per cycle is very low. Thus, it is of key importance to ensure very low losses at each reflection, otherwise, lasing will either not be possible, or will require too large current densities, not suitable for continuous wave operation. Since first proposed in 1962, VCSELs have become very popular. VCSELs can be made small, may operate at low threshold currents and are produced in a very production-friendly planar technology.

Another type of semiconductor laser is an edge-emitting laser, which is depicted in FIG. 1b. In this laser, an active medium (e.g., a thin layer) is placed in a waveguide having a larger refractive index than the surrounding cladding layers, to ensure a confinement of the laser light in the waveguide. The produced light is diffracted at the facet exit of the device at typically large angles of 30°-60°. The advantage of the edge-emitting laser is its compact output aperture which is realized simultaneously with high light output power. The disadvantage of the edge-emitting laser over the VCSEL is astigmatism phenomenon often occurring when circular output aperture are employed. Additionally, as opposed to the VCSEL, in the edge-emitting laser a temperature increase results in a significant wavelength shift caused by the bandgap narrowing of semiconductors with increasing temperature.

The radiation power of a semiconductor laser apparatus depends on its active area. The maximum output power is generally limited by irreversible mirror damage that begins at a defined light power density. For enhancing output power, the emission surface of the laser can be broadened parallel to the active zone, so that the emitted light power increases for the same maximum power density. Such solutions are referred to in the literature as broad stripe lasers.

A disadvantage of broad stripe lasers is that transverse mode operation along the p-n junction plane is not stable. On the one hand, broad stripe lasers operate in one or more higher order transverse modes, exhibiting a broad divergence in the far field radiation pattern, which pattern may fluctuate with time or with driving current. On the other hand, multiple filaments may be simultaneously established in the pumped regions of the light guiding active layer resulting in uncontrolled optical interference fringes in the laser beam.

An additional undesirable characteristic of broad stripe lasers is its wide-lobed emission pattern, which causes the laser emission to be especially undesirable, for example, because it makes it impossible to couple the radiation into a single mode optical fiber, or to achieve a collimated beam as required in free-space propagation communication systems. This poor quality of the laser beam becomes a particular problem at a high light output power and/or high power density.

Heretofore, the problem of poor beam quality has been thought as being unavoidable. Semiconductor lasers are thought to be highly nonlinear devices having a strong coupling between the gain of a laser and the refractive index, making it difficult to fabricate large aperture single-mode lasers [D. F. Welsh “A Brief History of High-Power Semiconductor Laser”, IEEE J. Sel Top. Quantum Electron. 6, pp. 1470-1477 (2000)]. At a certain width of the laser stripe, the optical field is not uniformly distributed through the aperture and the surface of the waveguide region, is rather concentrated in curved narrow filaments. This phenomenon is referred to as filamentation.

Filamentation can be directly revealed in electroluminescence intensity distribution, from both the facet and the top surface of the device. The width of the beam filaments is about a few micrometers, causing a strong impact on the far-field distribution of the device. First, a small width of the filaments results in a strong broadening of the far-field pattern, due to the self-diffraction effect. Second, even a small curvature of the beam filament near the facet leads to a strong tilting of the corresponding contribution to the far field pattern. As a result, the far field pattern of such a device is broadened and composed of lobes having different tilt angles. In addition, if the stripe width is large, high-order modes can be excited, further degrading the far-field pattern.

Several solutions to the problem of the far-field degradation are known. Typically, these solutions are directed at using an initially narrow gain region, where the beam filamentation is not important, and then to gradually extend the beam to a larger surface, as it is realized, for example in a device known as a tapered laser. In this approach, the initial “seed” beam from the narrow region causes stimulated emission in the tapered regions, and the filamentation effect is partially suppressed.

The disadvantage of this approach is that the optical gain in the lateral direction is non-uniform. A non-uniform distribution of nonequilibrium carriers is known to disturb the field distributions. As these parameters vary with injection current, the far field pattern becomes unstable. At a high power it becomes increasingly difficult to avoid feedback, assuming that formation of curved beam filaments is possible.

Another solution to the problem of the far-field degradation is to use an external cavity, which makes only one (usually, fundamental) mode available for the feedback in the system. For conventional lasers with a standard waveguide thickness (about 0.4 to 2 μm), however, it is difficult to couple light back to the laser cavity. Moreover, in this approach it is very difficult to avoid intrinsic lasing due to the Fabri-Perot cavity of the device. Typically, intrinsic lasing is reduced using antireflection coatings to achieve a very low reflectivity. However, these solutions become rather problematic in a material system, which is highly nonlinear as the refractive index and the gain are highly coupled [Welsh, supra].

In the field of narrow stripe single-mode devices, attempts have also been made to maintain beam quality up to the highest possible. In was proposed to use low reflectivity coatings made of Al₂O₃ to avoid kinks in the light-current characteristics [F. R. Nash, T. L. Paoli, and R. L. Hartman “Improvements of the electro-optic properties of (Al,Ga)As lasers by means of reduced reflection”, Journal of Applied Physics 52 (1981), pp. 48-54].

Attempts to increase single-mode output power of angled facet amplifiers using conventional single-layer antireflection coatings have led to a limited success [Z. Wang, B. Mikkelsen, and K. E. Stubkjaer “Influence of High Order Modes on Angled-Facet Amplifiers”, IEEE Photonics Technology Letters 3, pp. 366-368 (1991)]. Saitoh et al. (T. Saitoh, T. Mukai, O. Mukai “Theoretical Analysis and Fabrication of Antireflection Coatings on Laser-Diode Facets”, J. of Lightwave Technology LT3, 288-293 (1985)] considered bilayer facet coatings and demonstrated that double layer coatings are more advantageous for realization of ultralow-reflectivity applications. Multilayer coatings were addressed by J. Lee et al. [J. Lee, T. Tanaka, S. Sasaki, S. Uchiyama, M. Tsuchia, T. Kamiya “Novel Design Procedure of Broad-Band Multilayer Antireflection Coatings for Optical and Optoelectronic Devices”, J. of Lightwave Technology 16, 884-890 (1998)]. It was shown that a very low facet reflectivity (10⁻⁵) can be realized.

In spite of extensive research, however, high-order modes and wide-lobed emission pattern of ultra-wide aperture broad stripe lasers are still one of the major drawbacks.

Recently, lasers with considerable extended waveguides were proposed and demonstrated [N. N. Ledentsov and V. A. Shchukin “Novel concepts for injection lasers”, SPIE Optical Engineering, Volume 41, Issue 12, pp. 3193-3203 (2002)]. The waveguide thickness can be extended to 14 μm or more, resulting in a very narrow (6° to 7°) beam divergence along the fast axis. Furthermore, in these lasers the interaction of the optical mode and the gain medium is very small, resulting in a practically zero chirp and beam filamentation. Additionally, as the thickness of these waveguide significantly exceeds the wavelength of light in the medium, the laws of geometrical optics open new possibilities in further improvement of the beam quality.

Yet, for very broad stripes, where the beam filamentation is of less importance, the beam quality is still low, because of its multiple lateral modes.

There is thus a widely recognized need for, and it would be highly advantageous to have an extended waveguide apparatus capable of generating a laser beam characterized by a single or few modes and low beam divergence, devoid of the above limitations.

### SUMMARY OF THE INVENTION

According to one aspect of the present invention there is provided a selective reflector, for selectively preventing reflection of light passing therethrough. The selective reflector comprising at least one layer characterized by an angle-dependent reflectivity function. The angle-dependent reflectivity function being decreasing upon at least one interval, such that when an impinging angle of the light on a surface of the at least one layer is within a predetermined range, the reflection of light is substantially prevented.

According to further features in preferred embodiments of the invention described below, the light is a coherent light.

According to still further features in the described preferred embodiments the light is a laser light produced by an edge-emitting laser apparatus having an extended waveguide being adjacent or in proximity to the selective reflector.

According to still further features in the described preferred embodiments at least a portion of the predetermined range of the impinging angle is lower than a characteristic total internal reflection angle, calculated with respect to the extended waveguide and an ambient medium.

According to still further features in the described preferred embodiments the extended waveguide has a width of at least 5 micrometers.

According to still further features in the described preferred embodiments the light is a laser light produced by a surface-emitting laser apparatus having a cavity being adjacent or in proximity of the selective reflector.

According to still further features in the described preferred embodiments at least a portion of the predetermined range of the impinging angle is lower than a characteristic total internal reflection angle, calculated with respect to the cavity and an ambient medium.

According to still further features in the described preferred embodiments the cavity has a lateral dimension of at least 5 micrometers.

According to still further features in the described preferred embodiments the predetermined range of the impinging angle is from about 2 degrees to about 10 degrees.

According to another aspect of the present invention there is provided an apparatus for providing a laser radiation, the apparatus comprising: (a) a light-emitting device having an extended waveguide and an active region capable of generating light when exposed to an injection current; and (b) a feedback device for providing a feedback for generating a laser light. The feedback device comprising a selective reflector having at least one layer characterized by an angle-dependent reflectivity function. The angle-dependent reflectivity function being decreasing upon at least one interval, such that a reflection of the light is high for small impinging angles and low for large impinging angles of the light on a surface of the selective reflector.

According to further features in preferred embodiments of the invention described below, the active region is designed and constructed to emit the light through a surface of the active region.

According to still further features in the described preferred embodiments the active region is designed and constructed to emit the light through an edge of the active region.

According to still further features in the described preferred embodiments the apparatus is capable of emitting the laser in a single transverse optical mode.

According to still further features in the described preferred embodiments the apparatus is capable of emitting the laser in a single lateral optical mode.

According to still further features in the described preferred embodiments a stripe length of the light-emitting device and the injection current are selected such that a non-coherent light is generated solely by the injection current and the laser light is generated by a combination of the injection current and the feedback.

According to still further features in the described preferred embodiments the apparatus further comprises an external cavity designed such that the laser light is generated substantially in a fundamental transverse mode.

According to still further features in the described preferred embodiments the small impinging angles are substantially smaller than a characteristic total internal reflection angle of the extended waveguide.

According to still further features in the described preferred embodiments the light-emitting device comprises an n-emitter, adjacent to the extended waveguide from a first side and a p-emitter adjacent to the extended waveguide from a second side.

According to still further features in the described preferred embodiments the active region is formed between a first extended waveguide-region being doped by an n-impurity and a second extended waveguide-region being doped by a p-impurity, the first and the second extended waveguide-region being light transmissive.

According to still further features in the described preferred embodiments the active region is characterized by an energy bandgap which is narrower than an energy bandgap of the substrate.

According to still further features in the described preferred embodiments the active region comprises at least one layer.

According to still further features in the described preferred embodiments the active region comprises a system selected from the group consisting of a quantum wells system, a quantum wires system, a quantum dots system and any combination thereof.

According to still further features in the described preferred embodiments the light-emitting device comprises an edge-emitting semiconductor diode laser.

According to still further features in the described preferred embodiments a rear facet of the edge-emitting semiconductor diode laser is coated by a highly-reflecting coat.

According to still further features in the described preferred embodiments the extended waveguide comprises at least two parts each having a different refractive index such that the extended waveguide is characterized by a variable refractive index.

According to still further features in the described preferred embodiments the at least two parts of the extended waveguide comprise a first part having an intermediate refractive index and a second part having a high refractive index, the first and the second part are designed and constructed such that the fundamental transverse mode is generated in the first part, leaks into the second part and exit through a front facet of the light-emitting device at a predetermined angle.

According to still further features in the described preferred embodiments the apparatus serves as a leaky laser apparatus and capable of emitting the laser light in a single transverse optical mode.

According to still further features in the described preferred embodiments at least a portion of the extended waveguide comprises a photonic bandgap crystal.

According to still further features in the described preferred embodiments the photonic bandgap crystal comprises a structure having a periodically modulated refractive index, where the structure comprises a plurality of layers.

According to still further features in the described preferred embodiments the light-emitting device comprises at least one absorbing layer capable of absorbing light located within one layer of the photonic bandgap crystal.

According to still further features in the described preferred embodiments the light-emitting device comprises a plurality of absorbing layers such that each one of the plurality of absorbing layers is located within a different layer of the photonic band gap crystal.

According to still further features in the described preferred embodiments at least a portion of the extended waveguide comprises a defect being adjacent to a first side of the photonic bandgap crystal, the defect and the photonic bandgap crystal are selected such that the fundamental transverse mode is localized at the defect and all other modes are extended over the photonic band gap crystal.

According to still further features in the described preferred embodiments the defect comprises the active region.

According to still further features in the described preferred embodiments the active region has an n-side and a p-side.

According to still further features in the described preferred embodiments a total thickness of the photonic band gap crystal and the defect is selected so as to allow a low beam divergence of a fundamental transverse optical mode of the laser light.

According to still further features in the described preferred embodiments the light-emitting device comprises an n-emitter, adjacent to a second side of the photonic bandgap crystal, and a p-emitter being spaced from the photonic bandgap crystal by the defect and adjacent to the defect

According to still further features in the described preferred embodiments the n-emitter is formed on a first side of a substrate, the substrate being formed of a material selected from the group consisting of a III-V semiconductor, Si(111), cubic SiC(111), hexagonal SiC(0001), and sapphire(0001).

According to still further features in the described preferred embodiments the III-V semiconductor is selected from the group consisting of GaAs, InAs, InP and GaSb. According to still further features in the described preferred embodiments the laser structure is formed of semiconductors selected from the group consisting of GaN, AlN, InN and alloys of these materials.

According to still further features in the described preferred embodiments the light-emitting device comprises an n-contact being in contact with the substrate and a p-contact being in contact with the p-emitter.

According to still further features in the described preferred embodiments the light-emitting device comprises a p-doped layered structure having a variable refractive index, the p-doped layered structure being between the p-emitter and the defect.

According to still further features in the described preferred embodiments the variable refractive index is selected to prevent extension of the fundamental transverse mode to the n-contact and/or the p-contact.

According to still further features in the described preferred embodiments the p-emitter comprises at least one p-doped layer being in contact with the extended waveguide and at least one p+-doped layer being in contact with the p-contact.

According to still further features in the described preferred embodiments the defect further comprises a thin tunnel barrier layer for electrons, located on the n-side from the active region and sandwiched between a pair of additional layers.

According to still further features in the described preferred embodiments the defect further comprises a thin tunnel barrier layer for holes, located on the p-side from the active region and sandwiched between a pair of additional layers.

According to still further features in the described preferred embodiments the defect further comprises a first thin tunnel barrier layer for electrons, located on the n-side and sandwiched between a first pair of additional layers, and a second thin tunnel barrier layer for holes, located on the p-side and sandwiched between a second pair of additional layers.

According to still further features in the described preferred embodiments the first thin tunnel barrier layer is formed from a material selected from the group consisting of a weakly-doped n-layer and an undoped layer.

According to still further features in the described preferred embodiments the second thin tunnel barrier layer is formed from a material selected from the group consisting of a weakly-doped p-layer and an undoped layer.

According to still further features in the described preferred embodiments the defect further comprises a thick n-doped layer contiguous with one of the first pair of additional layers remote from the active region, and a thick p-doped layer contiguous with the second pair of additional layers remote from the active region.

According to still further features in the described preferred embodiments at least one of the first pair of additional layers is formed from a material selected from the group consisting of a weakly-doped n-layer and an undoped layer.

According to still further features in the described preferred embodiments at least one of the second pair of additional layers is formed from a material selected from the group consisting of a weakly-doped p-layer and an undoped layer.

According to yet another aspect of the present invention there is provided an apparatus for providing a laser radiation, the apparatus comprising: (a) a distributed Bragg reflector; (b) a cavity having therein an active region having a surface and capable of emitting light, through the surface, when exposed to an injection current; and (c) a feedback device for providing a feedback for generating a laser light. The feedback device comprises a selective reflector having at least one layer characterized by an angle-dependent reflectivity function. The angle-dependent reflectivity function is decreasing upon at least one interval, such that a reflection of the light is high for small impinging angles and low for large impinging angles of the light on a surface of the selective reflector.

According to further features in preferred embodiments of the invention described below, the apparatus further comprises an n-contact and a p-contact being respectively connected to the n-current and the p-current spreading layers.

According to still further features in the described preferred embodiments the apparatus further comprises an additional distributed Bragg reflector, positioned between the cavity and the feedback device.

According to still another aspect of the present invention there is provided an apparatus for providing a laser radiation, the apparatus comprising: (a) a first distributed Bragg reflector; (b) a cavity having therein an active region capable of emitting light, through its surface, when exposed to an injection current; (c) a second distributed Bragg reflector; and (c) a selective reflector having at least one layer characterized by an angle-dependent reflectivity function. The angle-dependent reflectivity function is decreasing upon at least one interval, such that a reflection of the light is high for small impinging angles and low for large impinging angles of the light on a surface of the selective reflector.

According to an additional aspect of the present invention there is provided an apparatus for providing a laser radiation, the apparatus comprising: a cavity having therein an active region capable of emitting light, through its surface, when exposed to an injection current. The cavity is interposed between a first feedback device and a second feedback device, each of the first and second feedback devices being capable of providing a feedback for generating a laser light, and comprising a selective reflector having at least one layer characterized by an angle-dependent reflectivity function. The angle-dependent reflectivity function being decreasing upon at least one interval, such that a reflection of the light is high for small impinging angles and low for large impinging angles of the light on a surface of the selective reflector.

According to further features in preferred embodiments of the invention described below, the apparatus further comprises an n-current spreading layer and a p-current spreading layer positioned such that the active region is interposed therebetween.

According to still further features in the described preferred embodiments the apparatus further comprises an n-contact and a p-contact being respectively connected to the n-current and a p-current spreading layers.

According to still further features in the described preferred embodiments the apparatus further comprises at least one additional layer interposed between the active region and the n-current spreading layer and/or between the active region and the p-current spreading layer.

According to still further features in the described preferred embodiments each of the at least one additional layer is independently formed of a material selected from the group consisting of a weakly n-doped semiconductor, a weakly p-doped semiconductor and an undoped semiconductor.

According to still further features in the described preferred embodiments the at least one additional layer comprises a first additional layer and a second additional layer.

According to still further features in the described preferred embodiments the apparatus further comprises at least one current aperture interposed between the first additional layer and the n-current spreading layer and/or between the second additional layer and the p-current spreading layer.

According to still further features in the described preferred embodiments the first feedback device comprises a Bragg reflector.

According to still further features in the described preferred embodiments the second feedback device comprises a Bragg reflector.

According to yet an additional aspect of the present invention there is provided a method of improving a quality of a laser beam, the laser beam being generated by an injection current and a feedback light, the method comprising passing the feedback light through a selective reflector and using the selective reflector for allowing reflection of the feedback light for small impinging angles and preventing reflection of the feedback light for large impinging angles of the feedback light on a surface of the selective reflector.

According to still further features in the described preferred embodiments the laser beam is produced by a laser apparatus having an extended waveguide.

According to still further features in the described preferred embodiments the angle-dependent reflectivity function comprises at least one local minimum, corresponding to the predetermined range of the impinging angle.

According to still further features in the described preferred embodiments each of the at least one layer of the selective reflector is independently made of a material selected from the group consisting of an amorphous dielectric material and a crystalline semiconductor material.

According to still further features in the described preferred embodiments the at least one layer of the selective reflector comprises two layers.

According to still further features in the described preferred embodiments the at least one layer of the selective reflector comprises a plurality of layers.

According to still further features in the described preferred embodiments the plurality of layers of the selective reflector are arranged in a periodic arrangement.

According to still further features in the described preferred embodiments the periodic arrangement of layers comprises three periods.

According to still further features in the described preferred embodiments each period of the three periods comprises two layers, each layer having a thickness and characterized by a refractive index, such that for each layer of the two layers, a ratio between a wavelength of the light and a respective thickness is substantially larger than four times a respective refractive index.

According to still further features in the described preferred embodiments the periodic arrangement of layers of the selective reflector comprises four periods.

According to still further features in the described preferred embodiments the periodic arrangement serves as a Bragg reflector.

According to still further features in the described preferred embodiments each period of the four periods comprises two layers, each layer having a thickness and characterized by a refractive index, such that for each layer of the two layers, a ratio between a wavelength of the light and a respective thickness equals about four times a respective refractive index.

According to still further features in the described preferred embodiments at least one of a thickness and a material of the plurality of layers of the selective reflector is selected so as to provide a reflectivity spectrum having a predetermined shape.

According to still further features in the described preferred embodiments the reflectivity spectrum comprises at least one stopband.

According to still further features in the described preferred embodiments at least one stopband of the reflectivity spectrum is sufficiently narrow so as to suppress reflectivity of at least one transverse optical mode other than a fundamental transverse mode of the light.

According to still further features in the described preferred embodiments the plurality of layers of the selective reflector is a selected such that when the impinging angle is small or zero, a frequency, or a photon energy of the light matches a local maximum of the reflectivity spectrum.

According to still further features in the described preferred embodiments the plurality of layers of the selective reflector is selected such that the at least one stopband has at least one dip.

According to still further features in the described preferred embodiments the at least one dip comprises a plurality of dips.

According to still further features in the described preferred embodiments the local maximum corresponds to a photon energy value being between photon energies of two successive dips.

According to still further features in the described preferred embodiments the local maximum corresponds to a photon energy value being lower than a lowest photon energy of the at least one stopband.

According to still further features in the described preferred embodiments the local maximum corresponds to a photon energy value being between photon energies of two successive stopbands of the reflectivity spectrum.

According to still further features in the described preferred embodiments the plurality of layers of the selective reflector comprises a first distributed Bragg reflector, a second distributed Bragg reflector, and at least one cavity interposed between the first and the second distributed Bragg reflectors.

According to still further features in the described preferred embodiments the at least one cavity comprises a first cavity, a second cavity and an optical tunnel region interposed between the first and the second cavities.

According to still further features in the described preferred embodiments the at least one optical tunnel region comprises a plurality of layers.

According to still further features in the described preferred embodiments the at least one optical tunnel region comprises a plurality of layers in a periodic arrangement.

According to still further features in the described preferred embodiments the predetermined range of the impinging angle is from about 2 degrees to about 12 degrees.

According to still further features in the described preferred embodiments the predetermined range of the impinging angle is from about 2 degrees to about 10 degrees.

According to still further features in the described preferred embodiments the small impinging angles are from zero to about 8 degrees.

According to still further features in the described preferred embodiments the large impinging angles are larger than about 8 degrees.

According to still further features in the described preferred embodiments the small impinging angles are from zero to about 6 degrees.

According to still further features in the described preferred embodiments the large impinging angles are larger than about 6 degrees.

According to still further features in the described preferred embodiments the small impinging angles are from zero to about 4 degrees.

According to still further features in the described preferred embodiments the large impinging angles are larger than about 4 degrees.

According to still further features in the described preferred embodiments the small impinging angles are from zero to about 2 degrees.

According to still further features in the described preferred embodiments the large impinging angles are larger than about 2 degrees.

The present invention successfully addresses the shortcomings of the presently known configurations by providing a selective reflector for improving a beam quality of a laser radiation and an apparatus for providing a laser radiation characterized by a single or few transverse modes and low beam divergence.

Unless otherwise defined, all technical and scientific terms used herein have the same meaning as commonly understood by one of ordinary skill in the art to which invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1a is a schematic illustration of a prior art Vertical Cavity Surface-Emitting Laser (VCSEL);

FIG. 1b is a schematic illustration of a prior art edge-emitting laser;

FIG. 2a is a schematic illustration of a prior art antireflector for a front facet of an edge-emitting laser;

FIGS. 2b-c are a calculated reflectivity spectrum of the prior art antireflector shown in FIG. 2a;

FIG. 3a is a schematic illustration defining the impinging angle of light coming from a waveguide of a laser apparatus onto the prior art antireflector;

FIGS. 3b-c is the reflection spectra of the prior art antireflector calculated for different impinging angles light;

FIGS. 4a-b are schematic illustrations of a selective reflector, according to a preferred embodiment of the present invention;

FIG. 5 is a schematic illustration of a laser apparatus which includes the selective reflector, according to a preferred embodiment of the present invention;

FIG. 6 is a schematic illustration of the apparatus of FIG. 5, which further comprises a highly reflecting coat, deposited on its rear facet, according to a preferred embodiment of the present invention;

FIG. 7 is a schematic illustration of an edge-emitting laser apparatus, which includes the selective reflector, in a preferred embodiment in which the concept of photonic bandgap crystal laser is employed;

FIG. 8 is a schematic illustration of a leaky edge-emitting laser apparatus which includes the selective reflector, according to a preferred embodiment of the present invention;

FIG. 9 is a is a schematic illustration of a surface emitting laser apparatus which includes the selective reflector, according to a preferred embodiment of the present invention;

FIG. 10 is a schematic illustration of the apparatus of FIG. 9, which further comprises an additional distributed Bragg reflector, according to a preferred embodiment of the present invention;

FIG. 11 is a schematic illustration of the apparatus of FIG. 9, in a preferred embodiment in which the selective reflector is formed of crystalline semiconductor materials;

FIG. 12 is a flowchart diagram of method of improving a quality of a laser beam, according to a preferred embodiment of the present invention;

FIG. 13a is a schematic illustration of a selective reflector having a two-layer configuration, according to a preferred embodiment of the present invention;

FIG. 13b shows the reflectivity spectra of the selective reflector of FIG. 13a, for seven values of impinging angles: 0°, 4°, 6°, 8°, 10°, 12° and 14°, according to a preferred embodiment of the present invention;

FIG. 13c shows the reflectivity of the selective reflector of FIG. 13a, as a function of the wavelength of light, for seven values of impinging angles: 0°, 4°, 6°, 8°, 10°, 12° and 14°, according to a preferred embodiment of the present invention;

FIGS. 14a-b show the angle-dependent reflectivity function, for a given wavelength of light, for the two-layer configuration of the selective reflector, according to a preferred embodiment of the present invention.

FIG. 15a is a schematic illustration of a selective reflector having three periods, according to a preferred embodiment of the present invention;

FIG. 15b shows the reflectivity spectrum of the selective reflector of FIG. 15a, according to a preferred embodiment of the present invention;

FIG. 15c shows the angle dependent reflectivity function of the selective reflector of FIG. 15a, according to a preferred embodiment of the present invention;

FIG. 16a is a schematic illustration of a selective reflector having four periods, according to a preferred embodiment of the present invention;

FIGS. 16b-c shows the reflectivity spectrum of the selective reflector of FIG. 16a, according to a preferred embodiment of the present invention;

FIGS. 17a-f show reflectivity spectra of the selective reflector of FIG. 16a, for six different impinging angles: 0° (FIG. 17a), 6° (FIG. 17b), 8° (FIG. 17c), 10° (FIG. 17d), 12° (FIG. 17e) and 14° (FIG. 17f), according to a preferred embodiment of the present invention;

FIGS. 18a-b show the angle-dependent reflectivity function of the selective reflector of FIG. 16a, according to a preferred embodiment of the present invention;

FIG. 19a is a schematic illustration of a selective reflector having a multi-period configuration and one cavity, according to a preferred embodiment of the present invention;

FIGS. 19b-c show the reflectivity spectrum of the selective reflector of FIG. 19a, according to a preferred embodiment of the present invention;

PIG. 19d is a schematic illustration of a selective reflector having a multi-period configuration and two cavities, according to a preferred embodiment of the present invention;

FIGS. 19e-f show the reflectivity spectrum of the selective reflector of FIG. 19d, according to a preferred embodiment of the present invention;

FIG. 20a shows the reflectivity spectra of the selective reflector of FIG. 19d, for five impinging angles: 0°, 6°, 8°, 10° and 12°, according to a preferred embodiment of the present invention;

FIG. 20b shows the angle-dependent reflectivity function of the selective reflector of FIG. 19d, according to a preferred embodiment of the present invention;

FIG. 21a is a schematic illustration of a selective reflector with two cavities in a preferred embodiment in which seven layers separate the two cavities;

FIG. 21b shows the angle-dependent reflectivity function of the selective reflector of FIG. 21a, according to a preferred embodiment of the present invention;

FIG. 22a is a schematic illustration of a Bragg reflector and a selective reflector, according to a preferred embodiment of the present invention;

FIG. 22b is a plot of ln(1/R) as a function θ for the configuration of FIG. 22a, where R is the angle-dependent reflectivity function and θ is the impinging angle of the light on the Bragg reflector, according to a preferred embodiment of the present invention;

FIG. 23a is a schematic illustration of a Bragg reflector and a selective reflector in a preferred embodiment in which the selective reflector is formed of crystalline semiconductor materials; and

FIG. 23b is a plot of ln(1/R) as a function θ for the configuration of FIG. 23a, according to a preferred embodiment of the present invention;

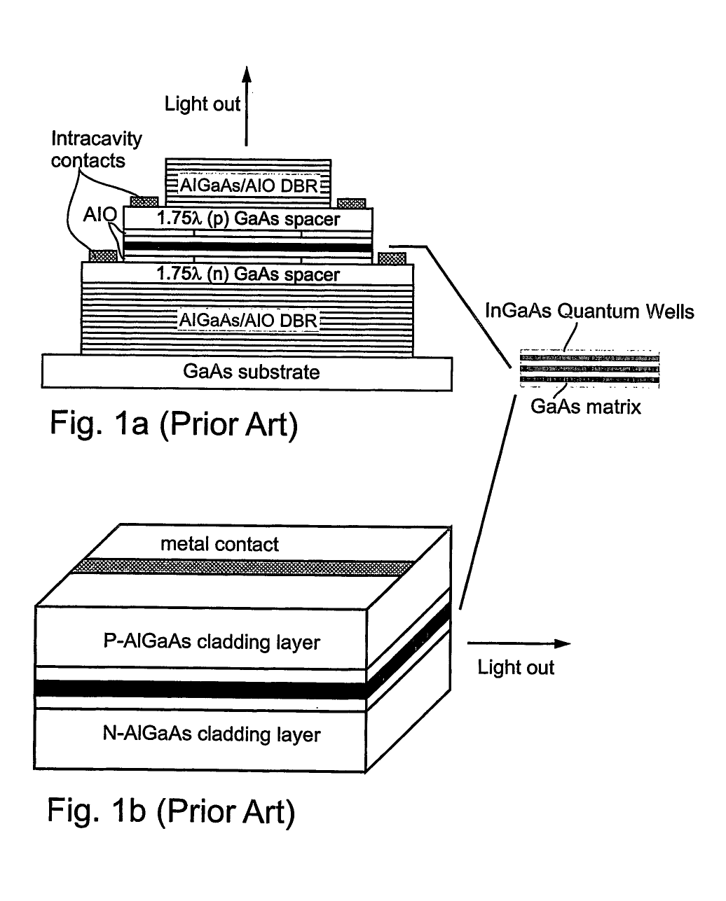

### DESCRIPTION OF THE PREFERRED EMBODIMENTS

The present invention is of a selective reflector which can be used for improving a beam quality of a laser radiation. Specifically, the present invention can be used to provide a laser radiation characterized by a single or few transverse modes and low beam divergence. The present invention is further of an apparatus for providing an improved laser radiation.

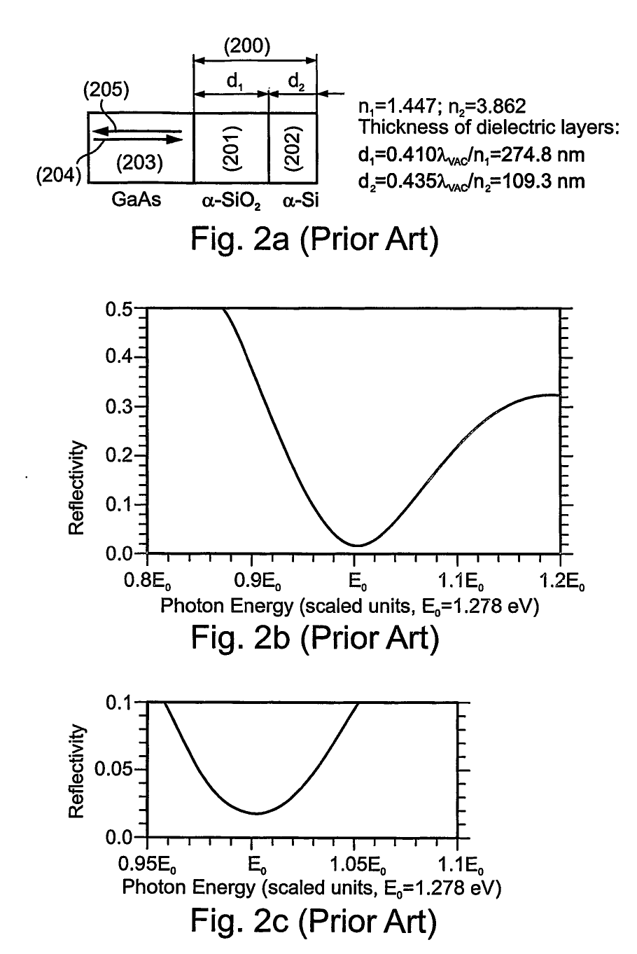

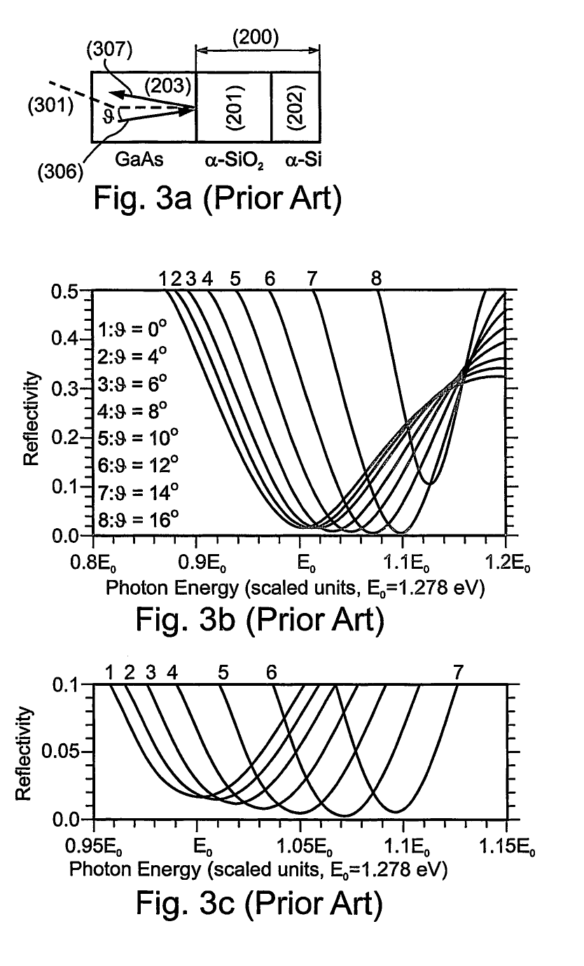

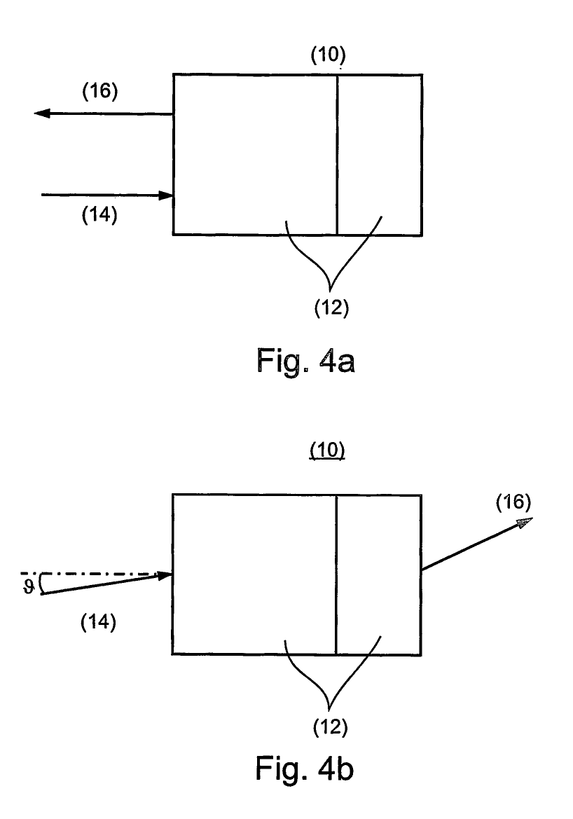

For purposes of better understanding the present invention, as illustrated in FIGS. 4-23 of the drawings, reference is first made to the construction and operation of a conventional (i.e., prior art) antireflector as illustrated in FIGS. 2-3.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

When a photon propagate from a first medium to a second medium, impinging on the boundary between the media, it can continue to propagate through the second medium, absorbed by the second medium or reflected from the boundary back to the first medium. Whether the photon continues its propagation, absorbed or reflected, depends on the energy of the photon, the nature of the two media (atomic structure, thickness, temperature, external electromagnetic fields) and on the angle at which the photon impinges on the boundary, referred to herein as impinging angle, and denoted by the Greek letter θ.

The nature of the materials is typically represented, to a good approximation, by their refractive indices. When the refractive index of the first medium is larger than the refractive index of the second medium, and the impinging angle is larger than a certain angle, known as the critical angle, the photon experience a phenomenon called total internal reflection in which it is reflected from the boundary back to the first medium, irrespectively of any other condition. The critical angle is also referred to as the total internal reflection angle.

As used herein, the phrase “characteristic total internal reflection angle” in conjunction with a medium through which light propagates, referes to the impinging angle at which the light does not exits from the medium into an ambient medium, e.g., air. More specifically, the “characteristic total internal reflection angle” can be used herein for the following situations: (i) the light is reflected back from the boundary of the medium and stays, at least temprarily, confined within the medium; (ii) the light is partially reflected and partially transmitted through the boundary of the medium, but does not propagate through the an ambient medium, for example, when one ore more layers separate between the medium and the ambient medium. For example, the phrase “characteristic total internal reflection angle of a waveguide” refers to the impinging angle at which the light is either reflected back from the boundary of the waveguide, or being in the form of evanescent electromagnetic field in proximity of the boundary of the waveguide, irresectively of whether or not the medium is separated from the ambient medium by one or more layers. In this case, the characteristic total internal reflection angle can be calculated from the refraction indices of the waveguide and the ambient medium. For example, denoting the refraction index of the waveguide at the wavelength of the propagating light by n₁, and the refraction index of the ambient medium by n_{A}, then the the characteristic total internal reflection angle of the waveguide, θ_{c}, can be calculated using the relation θ_{c}=arcsin (n_{A}/n₁).

When the impinging angle is smaller than the characteristic total internal reflection angle the combination of the above quantities determined whether or not the photon is reflected. Generally, when the photon propagates through a medium, it interacts with the atoms of the medium, resulting in either a scattering, whereby the photon changes its momentum (e.g., its direction of motion), or absorption, whereby the atom experience a transition to an excited state. In general, scattered photons destructively interfere with each other, with the exception of special orientations in which the photons interact with each other in such a way as to create constructive interference. The condition at which constructive interference occurs is known as Bragg's law (1912).

Referring now again to the Drawings, FIG. 2a is a schematic illustration of a prior art antireflector 200, which includes a first layer 201 and a second layer 202 and is adjacent to a waveguide 203. Light 204 exits from waveguide 203 and is reflected back thereto. The reflected light is designated in FIG. 2a by numeral 205. The thicknesses d₁ and d₂ of layers 201 and 202, respectively, are selected in accordance with the wavelength of light 204 in the vacuum, λ_{vac}, and the refractive indices of the material of which layers 201 and 202 are made. Typically, the thicknesses are expressed in terms of a ratio between λ_{vac} and the refractive index of the layer. In the prior art configuration shown in FIG. 2a, layer 201 is made of a-SiO₂, with a refractive index n₁=1.447, layer 202 is made of a-Si, with a refractive index n₂=3.862, and waveguide 203 is made of GaAs, having, at a wavelength of light λ_{vac}=970 nm, a refractive index n=3.525. For these refractive indices the thicknesses of layers 201 and 202 are, respectively, d₁=0.41λ_{vac}/n₁ and d₂=0.435λ_{vac}/n₂. Substituting a wavelength in a vacuum, λ_{vac}=970 nm, the absolute values of the thicknesses is d₁=274.8 nm and d₂=109.3 nm.

FIGS. 2b-c show the reflectivity spectrum of antireflector 200, when light 204 impinges on layer 201 at a zero impinging angle.

As used herein, the term “reflectivity spectrum” refers to the dependence of the reflectivity on the photon's energy. The term “reflectivity spectrum” is not to be confused with the general term “reflectivity” which refers to the value of the reflectivity, not necessarily as a function the frequency of light, or the photon energy.

The photon energy, E, in electron-volts (eV) is related to the wavelength of light through:

$$E ( eV ) = \frac{1240}{λ ( nm )} . \qquad ( EQ . 1 )$$

The photon energy the light is expressed in the reflectivity spectrum of FIGS. 2b-c in units of E₀, where E₀=1.278 eV corresponds to λ_{vac}=970 nm.

As shown in FIGS. 2b-c, for zero impinging angle the reflectivity is large (about 0.5) at E=0.85 E₀, and reaches a local minimal of about 0.002 at E=E₀.

As used herein the term “about” refers to ±10%.

Thus, prior art antireflector 200 is designed to prevent reflection of a 1.278 eV light impinging on layer 201 normal to its surface.

FIGS. 3a-c illustrate the reflectivity of antireflector 200 for oblique impingement of the light layer 201. Referring to FIG. 3a, light 306 impinges on layer 201 at an impinging angle, θ, relative to a normal 301 to layer 201, and is reflected back to waveguide 203. The reflected light is designated by numeral 307 in FIG. 3a.

FIG. 3b-c show the reflection spectra of antireflector 200 for different impinging angles of light 306. There are eight curves in FIG. 3b, designated 1-8 and respectively corresponding to the following values of impinging angle, θ: 0°, 4°, 6°, 8°, 10°, 12°, 14° and 16°. As shown in FIGS. 3b-c, the local minimum shifts with θ towards larger photon energies. For example, at θ=10° (curve No 5 in FIGS. 3b-c), the reflectivity spectrum has a local minimum at E=1.05 E₀ (as opposed to E=E₀ in the zero impinging angle case). When a light having a photon energy E₀ impinges on layer 201 at an impinging angle of 10°, the reflectivity is about 10 times larger compared to the value of the reflectivity the local minimum.

Thus, prior art antireflector 200 cannot prevent reflection of light when the light impinges on layer 201 at a non-zero impinging angle. The reflection of light 307 (i.e., having a non-zero angle relative to normal 301) results in an increment of the reflectivity and a stronger feedback for high-order modes of waveguide 203. This drawback is particularly problematic when antireflector 200 is employed in broad stripe lasers having wide apertures.

Prior art fail to teach the use of antireflectors for suppressing appearance of high-order modes in broad stripe lasers. This is because single mode operation has been achieved using simple stripe design approaches, while the major problem for high beam quality operation refers to beam filamentation. On the other hand, for traditional semiconductor lasers where a relatively narrow waveguide (0.4 to 1 μm), the confinement of light in a narrow region results in an uncertainty of angles of propagation of the optical modes. In such case the relation between the angle of propagation and the optical mode is not well defined.

The present invention successfully provide a selective reflector which is capable of suppressing appearance of high-order in many types of laser apparati, such as, but not limited to, edge-emitting laser apparati and surface-emitting laser apparati.

Thus, according to one aspect of the present invention there is provided a selective reflector 10 for selectively preventing reflection of light passing therethrough.

Reference is now made to FIGS. 4a-b, which are schematic illustration of selective reflector 10, according to a preferred embodiment of the present invention. Selective reflector 10 comprises at least one layer 12 which is characterized by an angle-dependent reflectivity function.

As used herein the term “angle-dependent reflectivity function”, also abbreviated to “reflectivity function”, refers to the angle-dependence of the reflectivity. The terms “angle-dependent reflectivity function” and its abbreviated form “reflectivity function”, are not to be confused with the terms “reflectivity spectrum” and “reflectivity” as defined hereinabove.

The angle-dependent reflectivity function is preferably a function of the impinging angle, θ, of light 14 on any of the layers of selective reflector 10, where θ is defined relative to normal 18 to the surface of layers 12. According to a preferred embodiment of the present invention, the reflectivity function is a decreasing function upon at least one interval of its argument, θ. The interval upon which the reflectivity function decreases is preferably selected such that when θ is within a predetermined range, the reflection of the light is substantially prevented (i.e., prevented or minimized).

For example, referring to FIG. 4a, when light 14 impinges on layers 12 at a small impinging angle (e.g., normal to the surface of layers 12), light 16 is reflected back. Referring to FIG. 4b, when light 14 impinges on layers 12 at a large impinging angle (but not larger than the characteristic total internal reflection angle), reflection of light 16 is prevented or minimized. For example, light 16 can be absorbed by, or exit from the other side of selective reflector 10.

Reflector 10 can be used to selectively prevent reflection of any light, such as, but not limited to, a coherent light generated by any laser apparatus. As stated, reflector 10 can be used in either an edge-emitting laser apparatus, including, without limitation, an edge-emitting laser apparatus having an extended waveguide (e.g., at least 5 μm in width), or a surface-emitting laser apparatus, including, without limitation, a surface-emitting laser apparatus having a wide cavity or large optical aperture (at least 5 μm in width).

According to a preferred embodiment of the present invention, the aforementioned predetermined range for which the reflection of light is prevented or minimized is lower than a characteristic total internal reflection angle of the waveguide or cavity of the laser apparatus. A preferred range of θ in which the reflection is prevented or minimized is 2°<θ<12°, more preferably 2°<θ<10°.

Minimization of reflection at certain and predetermined impinging angles, for a given photon energy (say, E₀) can be achieved by a judicious selection of the materials and the thicknesses of the layers forming selective reflector 10. In other words, a proper selection of the materials and thicknesses of the layers can be used to obtain a reflectivity spectrum and an angle-dependent reflectivity function having a predetermined shape. As further detailed hereinunder, and demonstrated in the example section that follows, when a plurality of layers is employed, e.g., in a periodic arrangement, the materials and thicknesses of the layers can be selected such that the reflectivity spectrum has at least one stopband, which is approximately centered at a predetermined photon energy.

Being capable of providing high reflectivity for light at the normal impingement or small impinging angles, and low reflectivity for light at large impinging angles, selective reflector 10 can be used to provide an efficient mode selection for any laser apparatus, by suppressing high-order modes and allowing lasing of a single or few modes.

According to an additional aspect of the present invention, there is provided an apparatus 50 for providing a laser radiation.

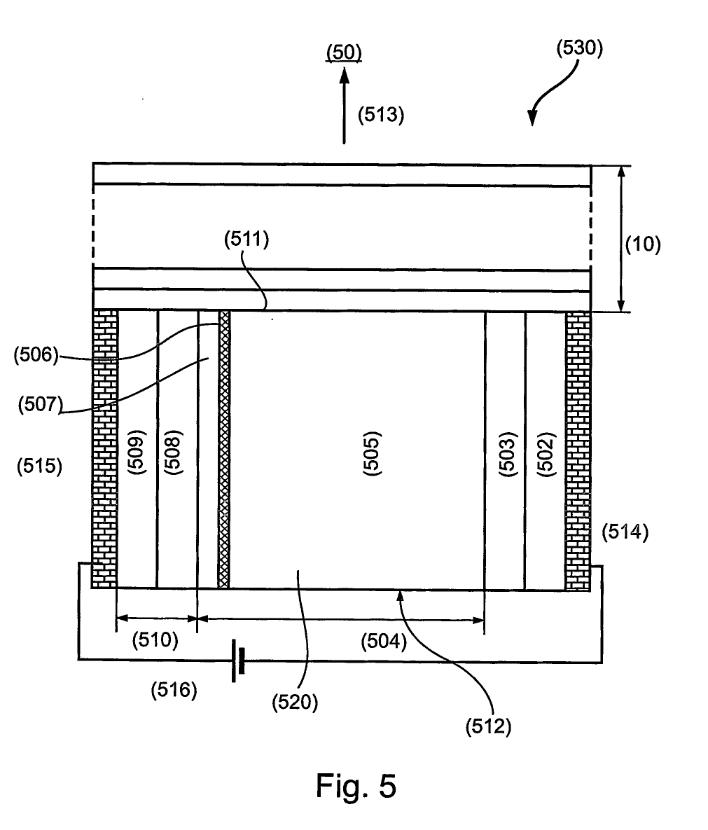

Reference is now made to FIG. 5 which is a schematic illustration of apparatus 50, according to a preferred embodiment of the present invention. Apparatus 50 comprises a light-emitting device 520 having an extended waveguide 504 and an active region 506 capable of generating light when exposed to an injection current. Apparatus 50 further comprises a feedback device 530 for providing a feedback for generating a laser light. Feedback device 530 preferably comprises selective reflector 10 as further detailed hereinabove.

According to a preferred embodiment of the present invention apparatus 50 is grown on a substrate 502, preferably formed from any III-V semiconductor material or III-V semiconductor alloy, e.g., InAs, InP, GaSb, or others. More preferably substrate 502 is made of GaAs. The crystallographic orientation of the substrate surface is preferably (001). Unless otherwise defined, wherever applicable below the crystallographic orientations of the substarte surface and, hence, the layers will be assumed (001).

A particular feature of apparatus 50 is extended waveguide 504 which, as stated, provides a light in which the fundamental transverse mode has a low beam divergence. According to a preferred embodiment of the present invention waveguide 504 is formed between an n-emitter 503 and a p-emitter 510, where n-emitter 503 is preferably grown directly on substrate 502 and being adjacent to waveguide 504 from one side, while p-emitter is adjacent to waveguide 504 from the other side.

Extended waveguide 504 preferably comprises an active region 506 formed between a first waveguide-region 505 being doped by an n-impurity and a second waveguide-region 507 being doped by a p-impurity. Both first 505 and second 507 regions are light transmissive.

First 505 and second 507 regions are preferably layers, or multi-layered structures formed of materials which are either lattice-matched or nearly lattice-matched to substrate 502.

Impurities which may be introduced into first waveguide-region 505 are donor impurities, such as, but not limited to, S, Se and Te. Alternatively first waveguide-region 505 may be doped by amphoteric impurities such as, but not limited to, Si, Ge and Sn, which may be introduced under such technological conditions that they are incorporated predominantly into the cation sub-lattice hence serve as donor impurities. Hence, first waveguide-region 505 may be, for example, GaAs or GaAlAs layers grown by molecular beam epitaxy and doped by Si impurities with a concentration of about 2×10¹⁷ cm⁻³.

Impurities which may be introduced into second waveguide-region 507 are acceptor impurities, such as, but not limited to, Be, Mg, Zn, Cd, Pb and Mn. Alternatively, second waveguide-region 507 may be doped by amphoteric impurities such as, but not limited to, Si, Ge and Sn, which may be introduced under such technological conditions that they are incorporated predominantly into the anion sub-lattice and serve as acceptor impurities. Hence, second waveguide-region 507 may be, for example, GaAs or GaAlAs layers grown by molecular beam epitaxy and doped by Be impurities with a concentration of about 2×10¹⁷ cm⁻³.

Active region 506 is preferably formed by any insertion having an energy band gap which is narrower than the energy gap of substrate 502. According to a preferred embodiment of the present invention active regions 506 may be, for example, a system of quantum wells, quantum wires, quantum dots, or any combination thereof Active region 506 may be formed either as a single-layer system or a multi-layer system. In the preferred embodiment in which substrate 502 is made of GaAs, active region 506 may be, for example, a system of insertions of InAs, In₁₋ₓGaₓAs, InₓGa_{1-x-y}Al_{y}As, InₓGa₁₋ₓAs_{1-y}N_{y} or similar materials, where x and y label an alloy compositions.

N-emitter 503 is preferably made of a material which is either lattice-matched or nearly lattice-matched to substrate 502, for example, the alloy material Ga₁₋ₓAlₓAs. In addition n-emitter 503 is preferably transparent to the generated light and doped by donor impurities, similarly to the doping of first waveguide-region 505 as further detailed hereinabove.

According to a preferred embodiment of the present invention p-emitter 510 comprises at least one p-doped layer 508 and at least one p+-doped layer 509, where p-doped layer 508 is positioned between waveguide 504 and p+-doped layer 509. Both p-doped layer 508 and p+-doped layer 509 are preferably light-transmissive, and are formed of a material, which is either lattice-matched or nearly lattice-matched to substrate 502. Layers 508 and 509 are doped with acceptor impurities, similarly to the doping of second waveguide-region 507. The difference between layer 509 and layer 508 is in the doping level. Preferably, whereas the levels of doping of second waveguide-region 507 and of p-doped layer 508 are similar, the doping level of p+-doped layer 509 is higher. For example, in the embodiment in which the doping level of second waveguide-region 507 is about2×10¹⁷ cm⁻³, p+-doped layer 509 may be a GaAlAs layer grown by molecular beam epitaxy and doped by Be impurity with a concentration of about 2×10¹⁹ cm⁻³.

A preferred thickness of device 50 is 5 μm or more, the preferred stripe width is from about 7 μm to about 10 μm or more, and a preferred length of device 50 is about 100 μm or more.

Forward bias 516 is preferably connected to edge-emitting diode 50 via an n-contact 514, being in contact with substrate 502, and a p-contact 517, being in contact with p-emitter 510 (or p+-doped layer 509). Contacts 514 and 515 may be realized using any known structures, such as, but not limited to, multi-layered metal structures. For example, n-contact 514 may be formed as a three-layered structure of Ni—Au—Ge, and p-contact 515 may be formed as a three-layered structure of Ti—Pt—Au.

The use of an extended waveguide typically results in a generation of a plurality of transverse optical modes of the laser light. In this case, the fundamental optical mode propagates along the direction of the waveguide and shows a narrow far-field diagram centered at a direction, which is normal to front facet 511 of apparatus 50. Propagation of high-order transverse optical modes may be described as occurring at some angle with respect to this direction.

An advantage of the presently preferred embodiment of the present invention is the use of selective reflector 10 on top of front facet 511. Light generated in active region 506 is extended over waveguide 504 and is bounced between front facet 511 and rear facet 512. Selective reflector 10 is designed such, that it provides a higher reflectivity for the normal incidence and a lower reflectivity for oblique incidence. Hence, external optical losses are lower for the transverse fundamental optical mode, and higher for transverse high-order optical modes. Additionally, the feedback for the transverse fundamental optical mode is stronger than the feedback for the transverse high-order optical modes. This ensures lasing in a single-mode or a few transverse modes.

In yet another embodiment of the present invention, the laser structure is comprised of semiconductor layers formed of nitrides of III-group elements. This means that the layers are formed of materials selected from the group consisting of GaN, AlN, InN, and any alloy of these materials. In this case the substrate 502 is preferably formed of a material selected from the group consisting of sapphire(0001), hexagonal SiC(0001), cubic SiC(111), and Si(111).

It will be appreciated that selective reflector 10 can also provide a medium antireflection effect for the normal incidence which ensures that laser light comes out through the front facet 511 rather than through the rear facet 512. To further facilitate the exit of light through front facet, apparatus 50 may further comprise a highly reflecting coat 620.

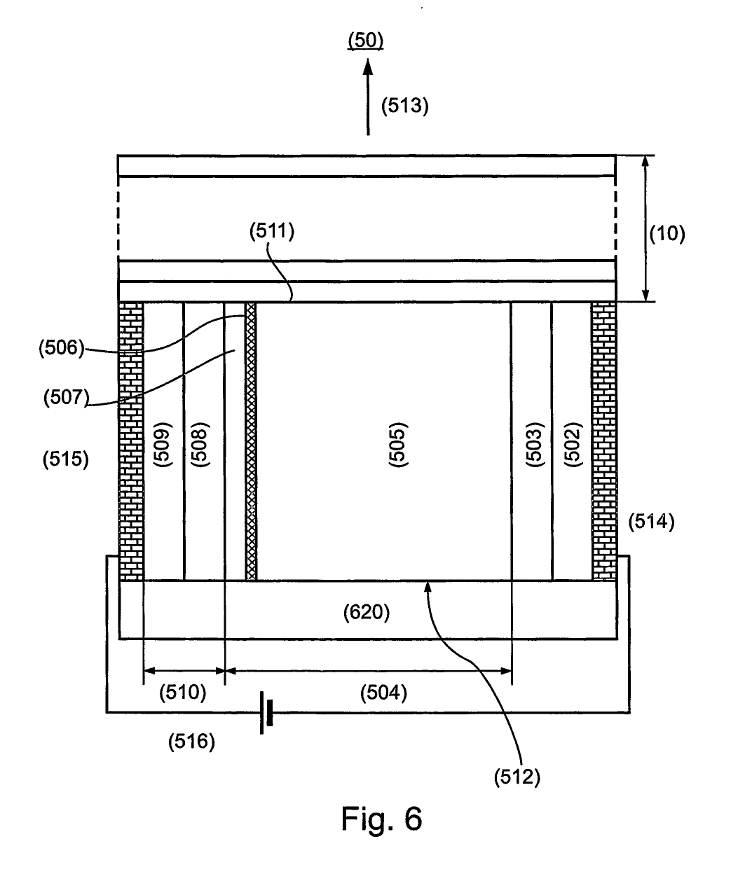

FIG. 6 is a schematic illustration of apparatus 50 in an embodiment in which a highly reflecting coat 620 is deposited on rear facet 512. Coat 620 ensures that light 513 exits through front facet 511 and selective reflector 10 rather than through rear facet 512.

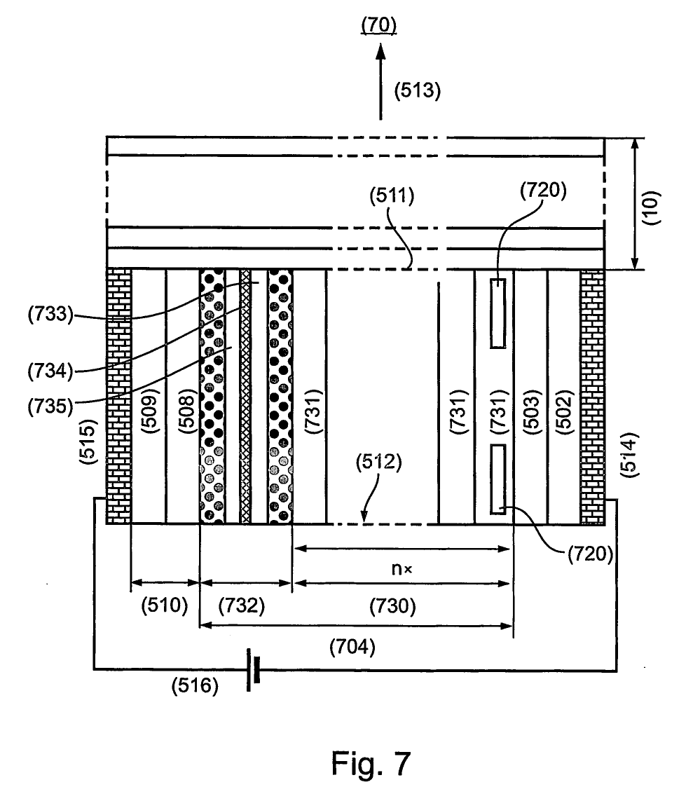

Reference is now made to FIG. 7, which is a schematic illustration of an edge-emitting laser apparatus 70 in a preferred embodiment in which the concept of photonic bandgap crystal laser is employed. To better identify the presently preferred embodiment of the invention, which is further detailed hereinbelow, the edge-emitting laser and the waveguide are designated in FIG. 7 by numerals 70 and 704, respectively.

Hence, in this embodiment, at least a portion of extended waveguide 704 comprises n periods 731 of a photonic bandgap crystal (PBC) 730. Each period 731 of PBC 730 is preferably formed from two n-doped layers one of low refractive index and one of high refractive index.

According to a preferred embodiment of the present invention light-emitting apparatus 70 comprises a defect 732 positioned between PBC 730 and p-doped layer 508. Defect 732 preferably comprises an active region 734 having an n-side 733 and a p-side 735, for emitting light when exposed to the injection current, e.g., using bias 516.

The concept of PBC lasers was first introduced in an article by Ledentsov, N. N. and Shchukin, V. A., entitled “Long Wavelength Lasers Using GaAs-Based Quantum Dots”, published in Photonics and Quantum Technologies for Aerospace Applications IV, Proceedings of SPIE, Donkor, E. et al., editors, 4732:15-26, 2002. Broadly speaking, a PBC is a multi-dimensional structure characterized by periodic refractive index modulation. Consider, for simplicity, a structure with a periodic modulation of the refractive index in only one, say z-direction. In an infinite, perfectly periodic PBC, the electromagnetic waves, or photons, are characterized by a well defined wave vector, kₓ in the x-direction and k_{y} in the y-direction, such that the spatial dependence of every component of the electric field, E, or magnetic field, H, on x and y spatial coordinates is described as a plane wave,
E,H˜exp (ikₓx) exp (ik_{y}y), (EQ. 3)
whereas the dependence on the z-coordinate is described, according Bloch's theorem, not as a plane wave but rather as a product of a plane wave and a periodic function, u(z), having the same period as the modulation of the refraction index. Thus, the total spatial dependence of the fields is:
E,H˜exp (ikₓx) exp (ik_{y}y) exp (ik_{z}z)u(z). (EQ. 4)

The characteristic bands of the frequency of electromagnetic waves, or of the photon energy comprise allowed bands, for which periodic electromagnetic waves propagate throughout the crystal, and forbidden bandgaps, for which no propagation of an electromagnetic wave is possible.

A perfect periodicity of the PBC can be deliberately broken by either a termination of a sequence of layers (insertions) or by any type of a defect which violates the periodical profile of the refractive index. Such a defect can either localize or delocalize the electromagnetic waves. In the case of a localizing defect, two types of electromagnetic waves are possible: (i) waves localized at the defect and decaying away from the defect and (ii) waves which extend over the entire PBC, where the spatial profile of the extended waves may be perturbed by a defect.

In a more traditional type of a laser based on a periodic sequence of layers the light propagates in the direction parallel to the refractive index modulation axis, say z, whereas the x- and y-components of the wave vector satisfy kₓ=0, and k_{y}=0. This situation is typical for a VCSEL. In this type of laser periodic sequences of layers are designed to provide high reflectivity spectral range (stopband) at some critical wavelength. The “defect” layer is designed to provide a confined mode within this stopband.

A strong advantage of the PBC laser as proposed by Ledenstov et al. is that this laser benefits from PBC properties, which are not related to reflection of particular wavelength. In this approach, the PBC is designed such that the periodic modulation of the refractive index occurs in the z-direction, whereas the main propagation of the light occurs in the x-direction. The periodicity is broken such that the light in the transverse fundamental mode is localized in the z-direction at the defect and decays away from the defect in the z-direction. In this case no general requirements for particular spectral position of the stopband in reflectivity or the external cavity thickness for the given wavelength exists. As the periodicity of the PBC is not directly related to the wavelength of propagating light, edge-emitting laser 70 may be used simultaneously for a wide range of wavelengths, e.g., 1 μm, 0.9 μm and 0.8 μm. One would appreciate that this property of laser 70 provides extremely high tolerances both in design and in manufacturing, which tolerances are particularly advantageous for direct frequency conversion.

The ability of defect 732 to localize modes of laser radiation is governed by two parameters. The first parameter is the difference between the refractive indices of defect 732 and the reference layer of the PBC, Δn. The second parameter is the volume of the defect. For a one-dimensional PBC, in which the refractive index is modulated in one direction only, the second parameter is the thickness of defect 732. Generally, as the value of Δn increases, at a fixed defect thickness, the number of modes being localized by the defect also increases. As the thickness of the defect increases, at a fixed Δn, the number of modes being localized by the defect also increases. These two parameters, Δn and the thickness of the defect, may be chosen so that one and only one mode of laser radiation is localized by defect 732. The other modes are extended over the PBC.

Hence, according to a preferred embodiment of the present invention defect 732 and PBC 730 are selected such, that the fundamental optical mode, which propagates in the direction perpendicular to the refractive index modulation axis, is localized at defect 732 and decays away from defect 732, whereas all other (high-order) optical modes are extended over the entire photonic band gap crystal. The gain region can then be placed directly at the defect of the photonic band gap crystal or close to it.

The desired refractive index profile throughout the entire structure is calculated as follows. A model structure is introduced. The fundamental TE-mode and the high-order TE modes are obtained from the solution of the eigenvector problem for the wave equation. As the fundamental mode is calculated, the far field pattern is calculated by using the method, given, e.g., in H. C. Casey, Jr. and M. B. Panish, Semiconductor Lasers, Part A, Academic Press, N.Y., 1978, Chapter 2. The desired structure is obtained as a result of the optimization providing the preferred interplay between the lowest beam divergence, the maximum amplitude of the fundamental mode in the active region, and the lowest ratio of the amplitudes of the higher modes at the active region to that of the fundamental mode.

As stated, active region 734 is preferably placed in defect 732 where the fundamental mode of laser radiation is localized. The required localization length of the fundamental mode is determined by the interplay of two tendencies. On the one hand, the localization length needs to be large enough to provide a low far-field beam divergence. On the other hand, the localization length should be sufficiently shorter than the length of the PBC. This provides efficient localization of the fundamental mode on the scale of the total thickness of the PBC and therefore a significant enhancement of the electric field strength in the fundamental mode compared to that of the other modes. For example, in one embodiment the PBC laser achieves a beam divergence of 4° while the confinement factor is 0.11 of that in a standard double heterostructure laser having a 0.8 μm GaAs cavity and Ga₁₋ₓAlₓAs cladding layers, where x=0.3.

According to a preferred embodiment of the present invention the materials from which contact layers 514 and 515 are made are selected so that only the extended high-order modes are scattered by layers 514 and 515 whereas the fundamental mode being well localized by defect 732, does not reach the contact region hence is not scattered. Appropriate materials for contact layers 514 and 515 include, e.g., alloyed metals.

In addition, edge-emitting laser 70 may further comprise one or more absorbing layers 720 located within one of the first layers 731 of PBC 730, away from defect 732 such that all extended high-order modes are absorbed, while the localized fundamental mode remains unaffected. Absorbing layers 720 may also be located such within different layers 731 of the PBC 730.

The PBC is preferably formed from a material lattice-matched or nearly lattice-matched to substrate 502 and transparent to the emitted light. In the above example of a device on a GaAs-substrate, the preferred embodiment is the alloy Ga₁₋ₓAlₓAs with a modulated aluminum composition, x. The number of periods, n, the thickness of each layer, and the alloy composition in each layer are preferably chosen to provide the localization of one and only one mode of laser radiation.

The number of layers in laser 70 and the location of the active region may vary, depending on the manufacturing process of laser 70 and on the application for which laser 70 is designed. Hence, one embodiment includes structures where the absorbing layers are introduced similar to the embodiment of FIG. 7, but the active region is located outside the defect. Another embodiment includes structures where the active region is located outside the defect and graded index layers are introduced between each layer with a low refractive index and a neighboring layer having a high refractive index. An additional embodiment, in which the active region is located outside the defect, includes thin tunnel barriers for carriers which surround the active region. Other embodiments of the present invention are possible where the active region is located outside the defect and some or all elements e.g., the absorbing layers, the graded-index layers and the thin tunnel barriers for carriers surrounding are included. Other embodiments of the present invention include structures where the defect is located either on the n-side or on the p-side from active region.

A preferred thickness of apparatus 70 is about 5 μm or more, the preferred number of periods 731 of PBC 730 is from about 5 to about 10 or more, the preferred stripe width is from about 7 μm to about 10 μm and more and the preferred length of apparatus 70 is about 100 μm or more.

The efficiency of laser 70 may be further enhanced by an appropriate leakage design, in which all the extended high-order modes are leaky and penetrate into substrate 502 or contact layers 514 and 515, as opposed to the fundamental mode, which, as stated, does not reach substrate 502 or contact layers 514 and 515 and does not suffer from any leaky loss.

One ordinarily skilled in the art will appreciate that the design of the photonic band gap crystal 730 provides an efficient selection of transverse optical modes in the vertical direction perpendicular to the plane of p-n junction. Selective reflector 10 acts in a complementary way and provides an efficient selection of transverse optical modes in the lateral direction in the plane of the p-n junction.

In one another embodiment, where the design of the photonic bandgap crystal 730 alone suppresses some of transverse vertical modes emitted by apparatus 70, but is yet not able to provide a single mode lasing with respect to transverse optical modes in the vertical direction, selective reflector 10 provides an additional mode selection also for transverse optical modes in the vertical direction, thereby to provide a single mode lasing even when an extended waveguide is employed. One may appreciate a particular embodiment, where photonic bandgap crystal 730 and selective reflector 10 are intentionally designed to act in a complementary way, such that one portion of the high order transverse optical modes is suppressed by the photonic bandgap crystal, and the other portion is suppressed by selective reflector 10.

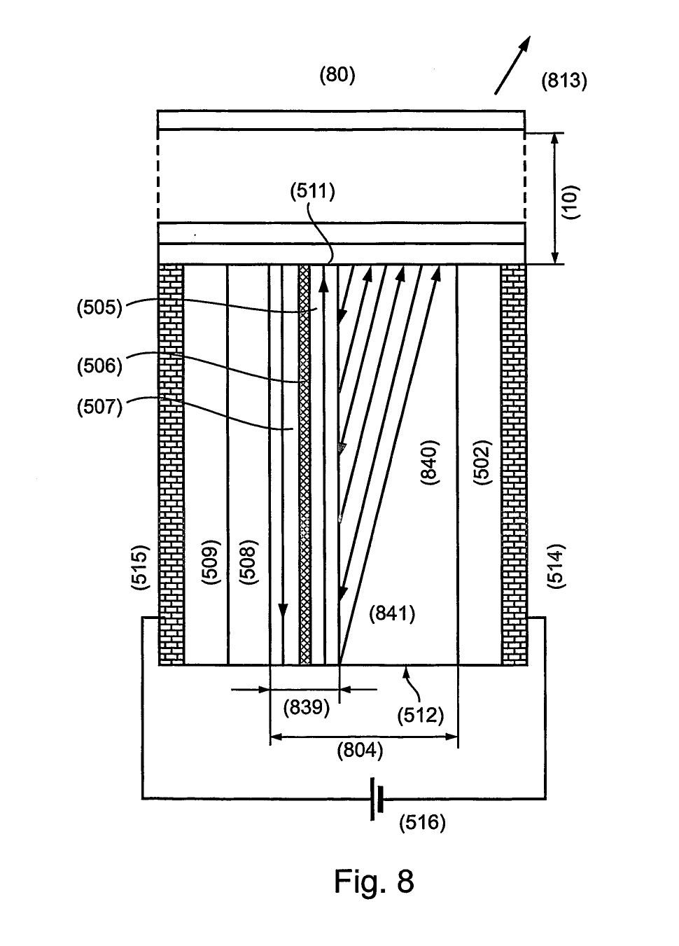

Reference is now made to FIG. 8, which illustrates an edge-emitting laser apparatus 80 in a preferred embodiment in which the laser is a leaky laser.

Hence, in this embodiment, waveguide 804 preferably comprises two parts, a first part 839 having an intermediate refractive index and preferably a second part 840 having a high refractive index. Active region 506 is sandwiched between layers 505 and 507 each of which is characterized by an intermediate refractive index. The light which is generated in active region 506 leaks out the first part 839 (with the intermediate refractive index) to the second part 840 (with the higher refractive index), propagates therethrough along a path 841, and exits 813 through front facet 511 and selective reflector 10. Propagation at a certain angle results in a feedback which selectively exists only for a single transverse leaky mode among a plurality of transverse modes in the vertical direction. However, a leaky laser alone provides normally no selectivity with respect to transverse optical modes in the lateral directions. Selective reflector 10 acts complementary to the leaky laser design, additionally suppressing high-order transverse optical modes in the lateral direction. Thus, according to a preferred embodiment of the present invention leaky laser 80 is capable of providing a single-mode or a few-modes lasing.

Second part of the extended waveguide 840, into which the leaking of the fundamental mode occurs, is preferably formed of a material, lattice-matched or nearly lattice-matched to substrate 502, transparent to the emitted light, n-doped, and having a high refractive index. The type of the doping impurity and the doping level are preferably the same as for layer 503 as further detailed hereinabove. For in the example of a device on a GaAs substrate, the preferred material is Ga₋₁ₓAlₓAs, where the modulated aluminum composition, x is chosen upon requirements on the refractive index.

Optionally and preferably, the leaky laser for generating the primary light may be manufactured such that waveguide 804 comprises only first part 839 (without second part 840). In this embodiment, the generated light leaks directly into substrate 502.

According to another aspect of the present invention, there is provided an surface emitting laser apparatus 1700.

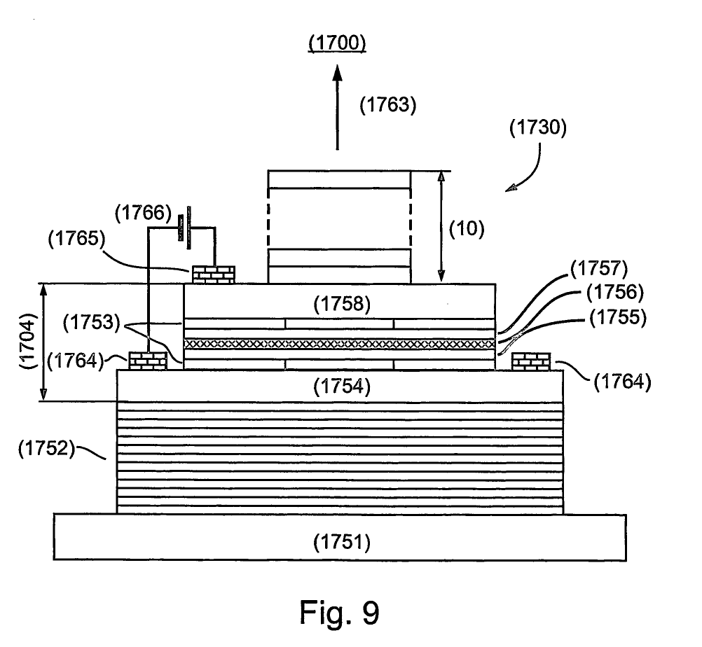

Reference is now made to FIG. 9, which is a schematic illustration of apparatus 1700. Apparatus 1700 is grown epitaxially on the substrate 1751 and comprises a distributed Bragg reflector 1752, and a cavity 1704 having an active region 1756. Apparatus 1752 further comprises a feedback device 1730 for providing a feedback for generating a laser light. Feedback device 1730 preferably comprises selective reflector 10 as further detailed hereinabove.

According to a preferred embodiment of the present invention, cavity 1704 comprises an n-current spreading layer 1754 with an n-metal contact 1764, a first current aperture 1753, a weakly n-doped layer 1755, an active region 1756, a weakly p-doped layer 1757, a second current aperture 1753, a p-current spreading layer 1758 with a p-metal contact 1765. Selective reflector 10 serves as a top distributed Bragg reflector.

First current aperture 1753 preferably interposed between layers 1754 and 1755, and second current aperture 1753 preferably interposed between layers 1757 and 1758. N-current spreading layer 1754 preferably positioned on top of Bragg reflector 1752.

In use, a forward bias 1766 is applied between contacts 1753 and 1765. A feedback is provided by a high reflectivity of Bragg reflector 1752 and selective reflector 10, so that a laser light 1763 is generated and exits, preferably through feedback device 1730. Alternatively, light 1763 can also exit through substrate 1751.

A particular feature of apparatus 1753 is selective reflector 10 which, as stated, preferably serves as a Bragg reflector. As stated, reflector 10 is capable of providing high reflectivity (e.g. close to unity) for the normal impingement of light, and, low reflectivity for oblique impingement of light. Such configuration provides an efficient selection of the lateral modes of apparatus 1700, and can results in a single-mode lasing even for large optical aperture (e.g., larger than 5 μm). Additionally, as further detailed hereinunder several selective reflectors 10 can be employed, for example, for better improving the beam quality of light 1763 or to allow light 1763 exit through substrate 1751.

According to a preferred embodiment of the present invention substrate 1751 is formed from any III-V semiconductor material or III-V semiconductor alloy, e.g., GaAs, InP, GaSb, or others.

N-doped layer 1754 can be formed from a material which is lattice-matched or nearly lattice-matched to substrate 1751. In addition, layer 1754 is preferably transparent to the generated light, and doped by donor impurities. Typically layer 1754 is made of the same material as substrate 1751. Representative examples of donor impurities include, without limitation, S, Se, Te and amphoteric impurities, such as, but not limited to, Si, Ge, Sn where the latter are introduced under such technological conditions that they are incorporated predominantly into the cation sublattice and serve as donor impurities.

P-doped layer 1758 can be formed from a material which is lattice-matched or nearly lattice-matched to substrate 1751. In addition, layer 1758 is preferably transparent to the generated light, and doped by an acceptor impurity. Typically layer 1758 is made of the same material as substrate 1751. Representative examples of donor impurities include, without limitation, Be, Mg, Zn, Cd, Pb, Mn and amphoteric impurities, such as, but not limited to, Si, Ge, Sn where the latter are introduced under such technological conditions that they are incorporated predominantly into the anion sublattice and serve as acceptor impurities.

Metal contacts 1764 and 1765 can be formed from the multi-layered metal structures. N-metal contact 1764 can be formed of, for example, Ni—Au—Ge. P-metal contact 1765 can be formed of, for example, Ti—Pt—Au.

Active region 1756 can be formed by any insertion, provided that its energy band gap is narrower than that of substrate 1751. Representative examples include, without limitation, a single-layer or a multi-layer system of quantum wells, quantum wires, quantum dots or their combination. In the embodiment in which a GaAs substrate is employed, active region 1756 can be formed of, for example, InAs, In₁₋ₓGaₓAs, InₓGa_{1-x-y}Al_{y}As, InₓGa₁₋ₓAs_{1-y}N_{y} and the like.

A weakly n-doped layer 1755 is preferably formed of a material which is lattice-matched or nearly lattice-matched to substrate 1751. Additionally, layer 1755 is preferably transparent to the emitted light and n-doped. According to a preferred embodiment of the present invention the doping impurities of layer 1755 are similar to the doping impurities of layer 1754. On the other hand, the doping level of layer 1755 is preferably lower than the doping level of the layer 1754. In one embodiment, layer 1755 is undoped.

A weakly p-doped layer 1757 is preferably formed of a material which is lattice-matched or nearly lattice-matched to substrate 1751. Additionally, layer 1757 is preferably transparent to the emitted light and p-doped. According to a preferred embodiment of the present invention the doping impurities of layer 1757 are similar to the doping impurities of layer 1758. On the other hand, the doping level of layer 1757 is preferably lower than the doping level of the layer 1758. In one embodiment, layer 1757 is undoped.

As stated, layers 1754 and 1755 are separated by current aperture 1753 and similarly layers 1757 and 1758. Current aperture 1753 serves as a current blocking layer and can be formed of, for example, Al(Ga)O layer or a proton bombardment layer.

In yet another embodiment of the present invention, apparatus 1700 is comprised of semiconductor layers formed of nitrides of III-group elements. This means that the layers are formed of materials selected from the group consisting of GaN, AlN, InN, and any alloy of these materials. In this embodiment substrate 1751 is preferably formed of a material selected from the group consisting of sapphire(0001), hexagonal SiC(0001), cubic SiC(111), and Si(111).

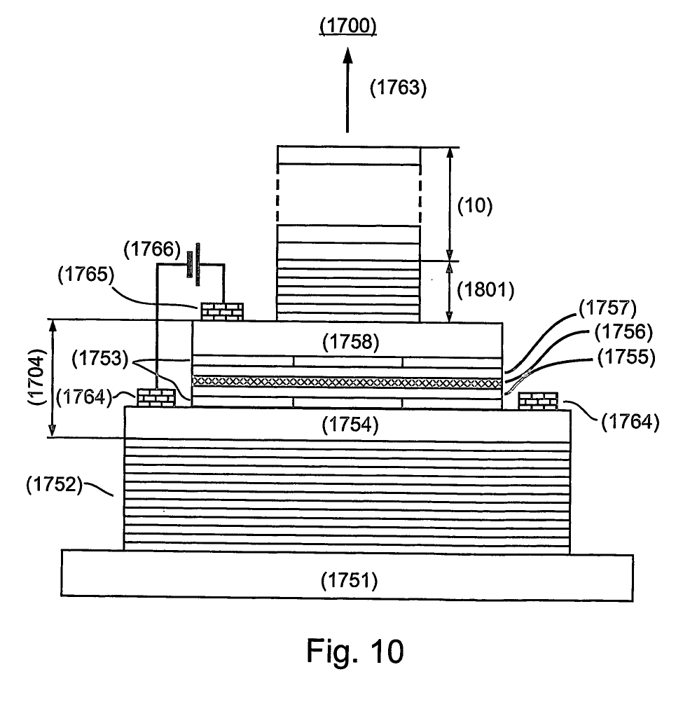

Reference is now made to FIG. 10, which is a schematic illustration of surface emitting laser apparatus 1700, which further comprise an additional distributed Bragg reflector 1801 positioned between p-current spreading layer 1758, and selective reflector 10, according to a preferred embodiment of the present invention. Bragg reflector 1801 is preferably formed of a sequence of alternating layers which are transparent to the emitted light and are either lattice-matched or nearly lattice-matched to substrate 1751. In an embodiment in which substrate 1751 is made of GaAs, the alternating layers can be formed of, for example, Ga₁₋ₓAlₓAs, where the value of x is alternating along Bragg reflector 1801. Alternatively, the alternating layers of Bragg reflector 1801 can be formed of, for example, an alternating sequence of a GaAlAs layer and a GaAs layer.

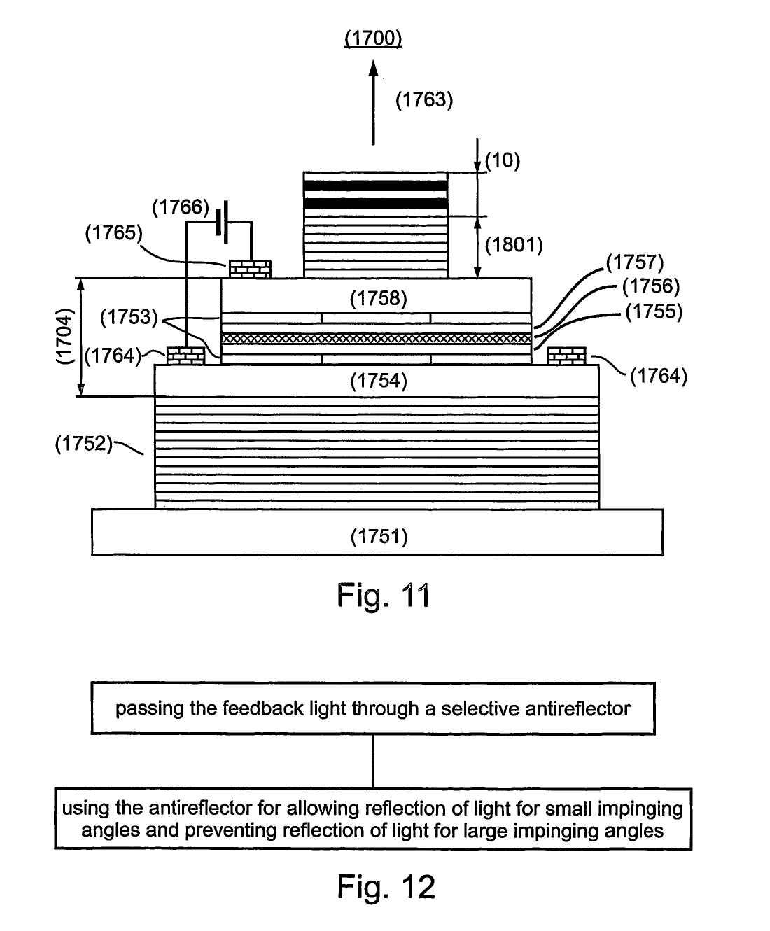

FIG. 11 is a schematic illustration of apparatus 1700 in a preferred embodiment in which selective reflector 10 is formed of crystalline semiconductor materials. Selective reflector 10 is preferably grown epitaxially on Bragg reflector 1801. According to a preferred embodiment of the present invention, selective reflector 10 is formed of alternating layers, lattice-matched or nearly lattice-matched, to substrate 1751, transparent to the emitted light and having different refractive indices. In an embodiment in which substrate 1751 is formed of GaAs, selective reflector 10 can be formed of, for example, Ga₁₋ₓAlₓAs layers where the value of x is alternating along selective reflector 10, or an alternating sequence of a GaAlAs layer and and a GaAs layer.

It will be appreciated that when selective reflector 10 is formed entirely of semiconductor layers grown epitaxially (see FIG. 11), there are many ways in which selective reflector 10 can be employed in apparatus 1700.

Generally, according to a preferred embodiment of the present invention one ore more of selective reflectors 10 can be positioned adjacent to or within any one of Bragg reflectors 1752 and 1801.

For example, in one embodiment, selective reflector 10 is positioned between cavity 1704 and Bragg reflector 1801.

In another embodiment, selective reflector 10 is positioned within Bragg reflector 1801, e.g., to divide Bragg reflector 1801, into a lower part and an upper part.

In an additional embodiment, a plurality of selective reflectors 10 are positioned within Bragg reflector 1801, e.g., in a periodic arrangement with the layers of Bragg reflector 1801.

In still an additional embodiment, selective reflector 10 is positioned between substrate 1751 and distributed Bragg reflector 1752.

In yet another embodiment, selective reflector 10 is positioned between Bragg reflector 1752 and cavity 1704.

In a further embodiment, selective reflector 10 is positioned within Bragg reflector 1752, e.g., to divide Bragg reflector 1752, into a lower part and an upper part.

In still a further embodiment, a plurality of selective reflectors 10 are positioned within Bragg reflector 1752, e.g., in a periodic arrangement with the layers of Bragg reflector 1752.

According to a further aspect of the present invention, there is provided a method of improving a quality of a laser beam. The laser beam may be generated, e.g., by an injection current and a feedback light, using any laser apparatus, such as, but not limited to, an edge emitting laser apparatus or a surface emitting laser apparatus.

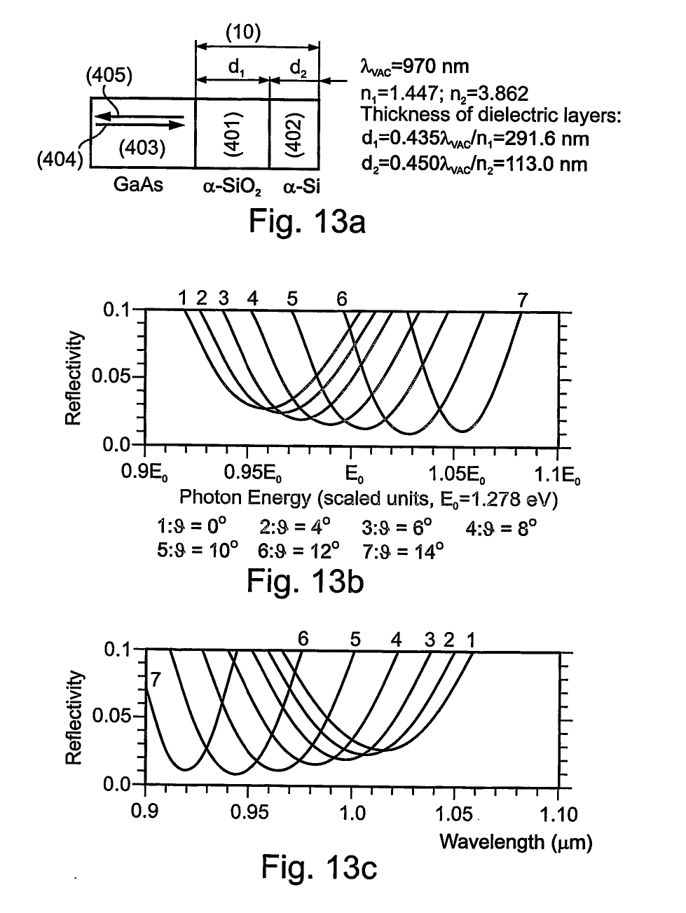

Referring now again to the drawings, the method comprises the following method steps which are illustrated in the flowchart of FIG. 12. Hence, in a first step the feedback light is passed through a selective reflector, e.g., selective reflector 10, and in a second step, the selective reflector is used for allowing reflection of the feedback light for small impinging angles and preventing reflection of the feedback light low for large impinging angles, as further detailed hereinabove.

It is expected that during the life of this patent many relevant semiconductor laser apparati will be developed and the scope of the terms edge emitting laser apparatus and surface emitting laser apparatus are intended to include all such new technologies a priori.

Additional objects, advantages and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions illustrate the invention in a non limiting fashion.

### Example 1

### A Two-Layer Configuration

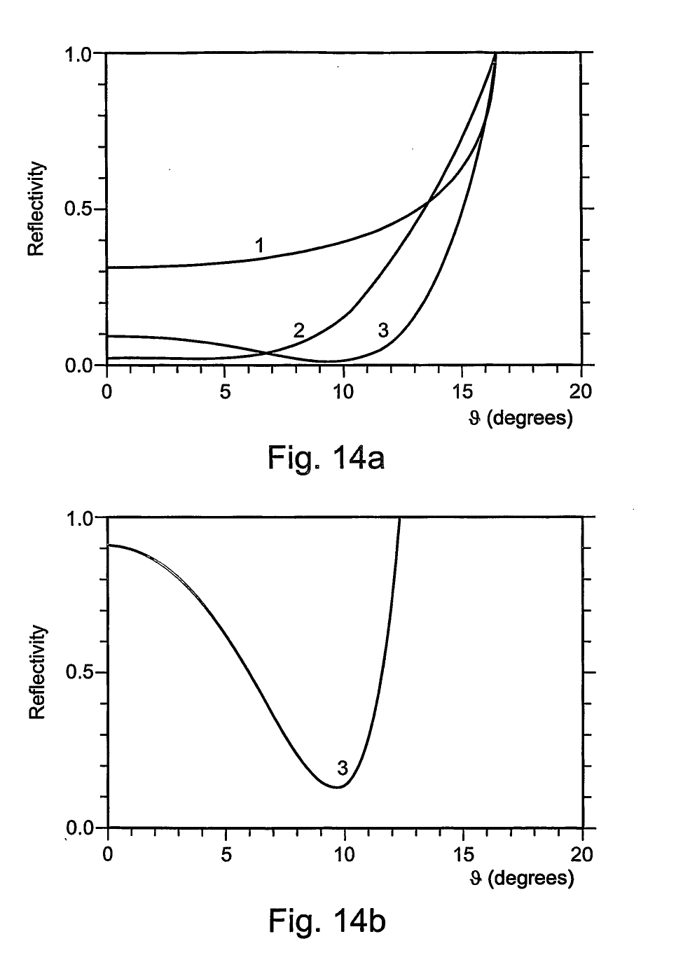

Reference is now made to FIG. 13a, which is a schematic illustration of selective reflector 10, according to a preferred embodiment of the present invention, in which a two-layer configuration is employed.

In this embodiment selective reflector 10 comprises a first layer 401 and a second layer 402. Also shown is a waveguide or cavity 403 being adjacent to first layer 401. Waveguide or cavity 403 may be an element of any apparatus (not shown) with which selective reflector 10 is employed, for example a waveguide of an edge-emitting laser apparatus or a cavity of a surface-emitting laser apparatus. In use, light 404 exits from waveguide 403, impinges on selective reflector 10 and reflects back to the waveguide. The reflected light is designated in FIG. 13a by numeral 405.

Layers 401 and 402 are preferably formed of materials having different refractive indices, such the layer 401 is formed of a material having a different refractive index than waveguide or cavity 403. According to a preferred embodiment of the present invention layers 401 and 402 are formed of amorphous dielectrics. Representative examples of suitable amorphous dielectrics include, without limitation, a-SiO₂, a-Si, a-LiF or a-Si₃N₄.

For example, in one embodiment, layer 401 is formed of a-SiO₂, layer 402 is formed of a-Si, and waveguide 403 is formed of GaAs. According to a preferred embodiment of the present invention, for such materials, the thickness of layer 401, d₁, is about 0.435λ_{vac}/n₁=291.6 mn and the thickness of layer 402, d₂, is about 0.450λ_{vac}/n₂=113.0 nm, where n₁=1.447 and n₂=3.862 are the refractive indices of a-SiO₂ and a-Si, respectively.

FIG. 13b shows the reflectivity spectra of selective reflector 10, for different values of impinging angles, θ, in the embodiment in which the aforementioned materials and thickness are employed. The photon energy, E, of the light is expressed in the reflectivity spectrum of FIG. 13b in units of a reference photon energy E₀.

It is to be understood that the aforementioned wavelength λ_{vac}=970 nm, and the corresponding photon energy E₀=1.278 eV are not to be considered as limiting, and that other wavelengths as well as photon energies are contemplated. Representative examples of suitable wavelengths and corresponding photon energies include, without limitation, λ_{vac}=1550 nm (E₀=0.8 eV), λ_{vac}=1480 nm (E₀=0.838 eV), λ_{vac}=1300 nm (E₀=0.954 eV), λ_{vac}=1100 nm (E₀=1.127 eV), λ_{vac}=980 nm (E₀=1.265 eV), λ_{vac}=940 nm (E₀=1.319 eV), λ_{vac}=850 nm (E₀=1.459 eV), λ_{vac}=810 nm (E₀=1.531 eV), λ_{vac}=780 nm (E₀=1.590 eV), λ_{vac}=650 nm (E₀=1.908 eV), etc.

There are seven curves in FIG. 13b, designated 1-7 and respectively corresponding to the following values of impinging angle, θ: 0°, 4°, 6°, 8°, 10°, 12° and 14°. As shown in FIG. 13b, the reflectivity spectrum has a local minimum at E=E₀, for θ=10°. Thus, selective reflector 10 is capable of preventing or minimizing the reflection of the light when the impinging angle of light 404 is about θ=10°. Furthermore, selective reflector 10 allows reflection at smaller angles (e.g., θ<6°).

FIG. 13c shows the reflectivity of selective reflector 10 as a function of the wavelength of light 404. In the calculation performed to present FIG. 13c, the following frequency dispersion of the refractive indices of the materials were approximated:
a-SiO₂: n₁=1.43+0.0161Eₚₕₒₜₒₙ (eV)−0.00214E²ₚₕₒₜₒₙ (eV) (EQ. 2a)
a-Si: n₂=3.284+0.1373Eₚₕₒₜₒₙ (eV)+0.2482E²ₚₕₒₜₒₙ (eV) (EQ. 2b)
GaAs: n₃=4.723−2.348Eₚₕₒₜₒₙ (eV)+1.108E²ₚₕₒₜₒₙ (eV) (EQ. 2c)

The reflectivity shown in FIG. 13c has a similar behavior as in FIG. 13b, revealing, for light at the incidence angle of θ=10°, a reflectivity minimum close to a wavelength 0.97 μm.

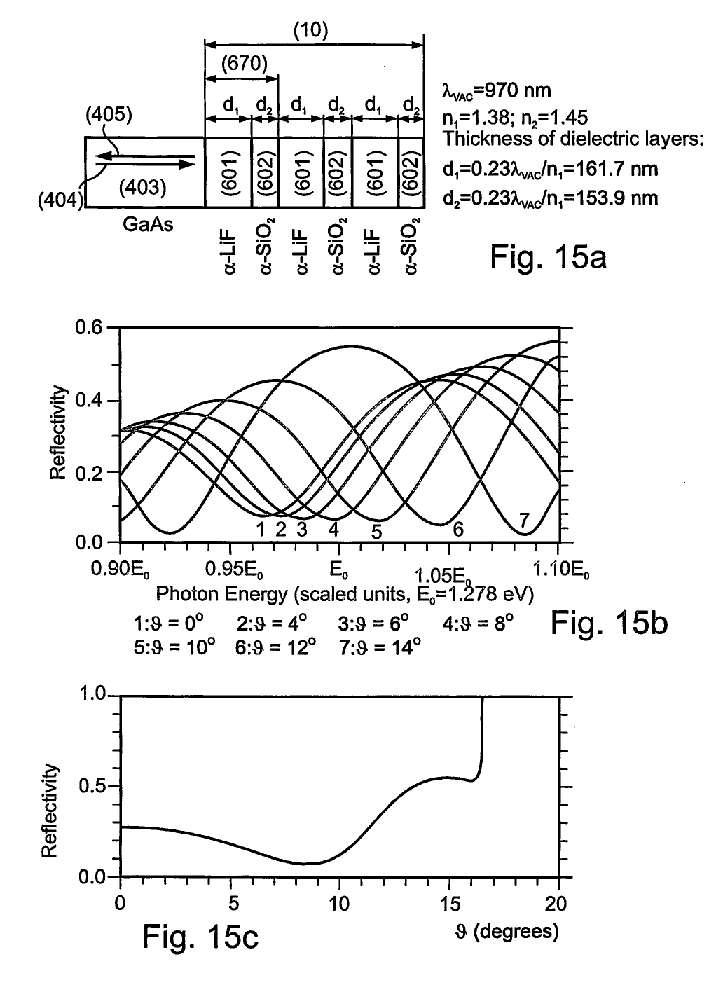

FIGS. 14a-b show the angle-dependent reflectivity function, for a given wavelength of light. In FIG. 14a, curve 1 corresponds to a bare facet of waveguide 403, i.e., when selective reflector 10 is not employed; curve 2 corresponds to prior art antireflector 200 (see FIG. 2a); and curve 3 corresponds to selective reflector 10 in the two-layer embodiment of the present example.

As shown in FIG. 14a, a monotonic and rapid increase in the reflectivity with the angle θ is observed for curves 1 (no selective reflector) and 2 (prior art antireflector 200). Although for a particular impinging angle, θ, the use of prior art antireflector 200 reduces the reflectivity relative to a bare facet, there is no interval of θ upon which the reflectivity function decreases. As shown in FIG. 14b, curve 3 exhibits a decrement in the interval 0<θ<10°, thus suppressing (by a factor of about 2) reflection of light impinging on layer 401 at large angles (about 6°-11°). The reflectivity function exhibits an increment in the interval 10°<θ<16.5°, where total internal reflection occurs on a boundary between waveguide 403 and an ambient medium, e.g., air.

In embodiments in which the waveguide and the ambient medium are separated by one or more one layers, the total internal reflection is still defined with respect to the optical charactersitics of waveguide 403 and the ambient medium, irrespectievely of the optical charactersitics of the layer(s) which separate waveguide 403 and the ambient medium. In other words, the total internal reflection angle is the angle which governs whether the light can propagate outside the structure into the ambient medium, or can not propagate and is present in the proximity of the surface of waveguide 403 in the form of evanescent electromagnetic field.

### Example 2

### A Periodic Configuration with Three Periods

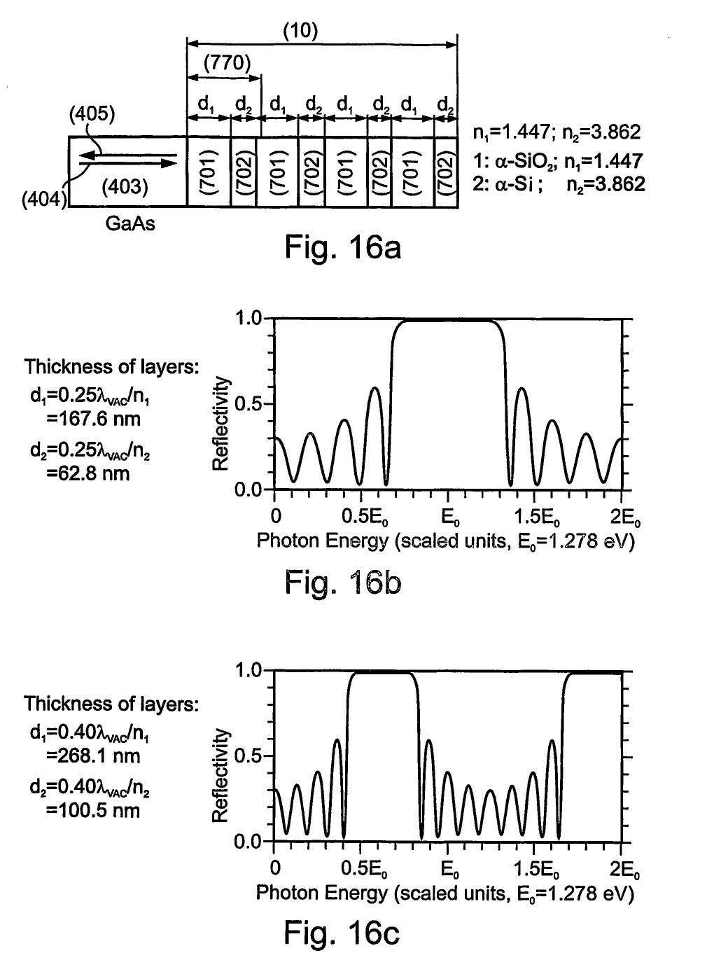

FIG. 15a shows selective reflector 10 in an embodiment in which three two-layer periods 670 are employed. According to a preferred embodiment of the present invention, selective reflector 10 comprises 3 periods 670, each having a first layer 601 and a second layer 602. Layers 601 and 602 are preferably formed of materials, having a small difference in refractive indexes, such that layer 601 is formed of a material, having a refractive index different from that of waveguide 403. For example, in one embodiment, layer 601 is formed of amorphous dielectrics a-LiF, and layer 602 is formed of amorphous dielectrics a-SiO₂.

One ordinarily skilled in the art would appreciate that when the thicknesses dᵢ and the refractive indices nᵢ of the layers 601 and 602 satisfy the criterion λ_{vac}/dᵢ≦4 nᵢ, selective reflector 10 becomes a low quality distributed Bragg reflector. In such undesired case, the reflector is not selective, because the reflectivity function is monotonic and has no interval upon which it decreases. Thus, according to a preferred embodiment of the present invention layers 601 and 602 are different from the layers of conventional, low quality, Bragg reflector. This can be done by selecting sufficiently thin layers, such that, for each layer of thickness dᵢ and refractive index nᵢ, the ratio λ_{vac}/dᵢ is larger than 4 nᵢ.

Hence, in one embodiment, the thicknesses of layer 601 is d₁=0.23λ_{vac}/n₁, and the thickness of the layer 602 is d₂=0.23λ_{vac}/n₂. In the embodiment in which layer 601 is formed of a-LiF, and layer 602 is formed of a-SiO₂, the absolute values of d₁ and d₂, for λ_{vac}=970 nm, are d₁=161.7 nm and d₂=153.9 nm.

FIG. 15b shows the reflectivity spectrum of selective reflector 10 in the embodiment in which three periods 670 are employed. There are seven curves in FIG. 15b, designated 1-7 and corresponding to the seven θ values of FIG. 13b. As shown in FIG. 15b, the local maximum of the reflectivity spectrum for θ=0 is shifted towards larger photon energies. The reflectivity spectrum has a local minimum close to E=E₀, for θ=8°. Thus, selective reflector 10 is capable of preventing or minimizing the reflection of the light when the impinging angle of light 404 is about θ=8°. Furthermore, selective reflector 10 allows reflection at smaller angles (e.g., θ<6°).

FIG. 15c shows the angle-dependent reflectivity function, for a given wavelength of light, in the embodiment in which three periods 670 are employed. As shown in FIG. 15c, reflectivity function decreases in the interval 0<θ<8.5°, thus suppressing reflection of light impinging on layer 401 at large angles (about 7°-10°). Such angular selectivity of the reflectivity function allows to efficiently suppress high-order optical modes of the waveguide. The reflectivity function exhibits an increment almost monotonically, in the interval 8.5°<θ<16.5°, where at θ=16.5° total internal reflection occurs on the boundary between waveguide 403 and selective reflector 10.

### Example 3

### A Periodic Configuration with Four Periods

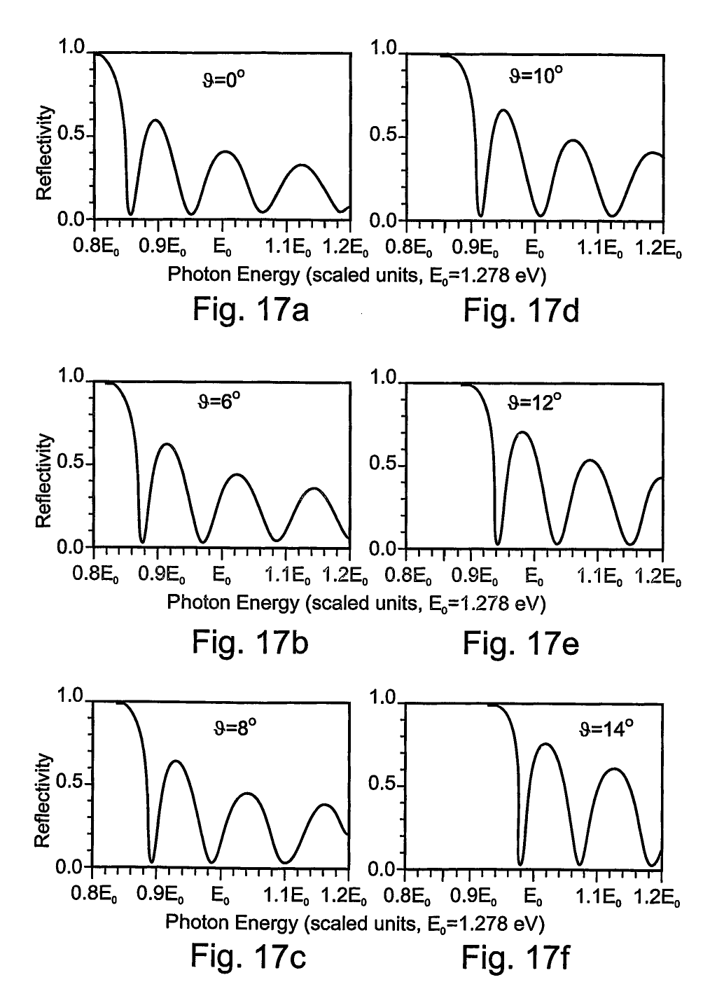

FIG. 16a is a schematic illustration of selective reflector 10 in a preferred embodiment in which four periods 770 are employed. In this embodiment, each period comprises a first layer 701 and a second layer 702.

Layers 701 and 702 are preferably formed of materials having different refractive indices, such the layer 701 is formed of a material having a different refractive index than waveguide 403. Similarly to layers 401 and 402 above, layers 701 and 702 are preferably formed of amorphous dielectrics. Representative examples of suitable amorphous dielectrics include, without limitation, a-SiO₂, a-Si, a-LiF and a-Si₃N₄.

According to a preferred embodiment of the present invention the thicknesses of layers 701 and 702 are selected such that reflectivity spectrum of selective reflector 10 has a sufficiently wide stopband approximately centered at the photon energy of the light, E₀. This can be done, for example, by selecting thicknesses of d₁=0.25λ_{vac}/n₁ for layer 701 and d₂=0.25λ_{vac}/n₂ for layer 702. In the embodiment in which layer 701 is formed of a-LiF, and layer 702 is formed of a-SiO₂, the absolute values of d₁ and d₂, for λ_{vac}=970 nm, are d₁=167.6 nm and d₂=62.8 nm.

FIG. 16b which shows the reflectivity spectrum at normal incidence (θ=0) of selective reflector 10 in the embodiment in which four periods 770 are employed. As shown, in this embodiment, selective reflector 10 serves as a high quality distributed Bragg reflector. Specifically, the reflectivity spectrum of selective reflector 10 has a wide stopband approximately centered at E₀. Additionally, a set of local maxima is observed on both sides of the stopband.

Alternatively, the thicknesses of layers 701 and 702 can be selected such that one of the additional local maxima is located at E₀. This can be done by selecting thicker layers, for example, d₁=0.40λ_{vac}/n₁ for layer 701 and d₂=0.40λ_{vac}/n₂ for layer 702. In the embodiment in which layer 701 is formed of a-LiF, and layer 702 is formed of a-SiO₂, the absolute values of d₁ and d₂, for λ_{vac}=970 nm, are d₁=268.1 nm and d₂=100.5 nm.

FIG. 16c shows the reflectivity spectrum at normal incidence (θ=0) of selective reflector 10 having four periods 770 in the embodiment in which four periods 770 comprise thicker layers. As shown, a wide stopband is approximately centered at E=0.7 E₀, and the second side maximum at the right-hand-side of the stopband is located at E₀. Thus, for a given group of materials (and refractive indices) the shape of the reflectivity spectrum can be provided by altering the thicknesses of layers 701 and 702.

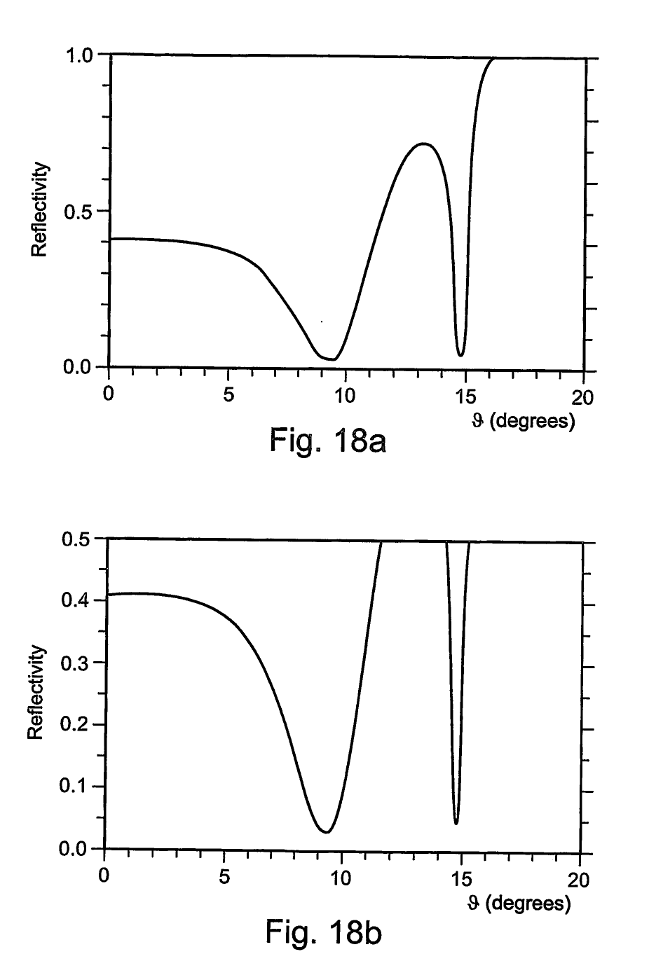

FIGS. 17a-f show reflectivity spectra of selective reflector 10 with four periods 770 in the embodiment in which four periods 770 comprise thicker layers. Shown in FIGS. 17a-f are spectra for six different impinging angles: 0° (FIG. 17a), 6° (FIG. 17b), 8° (FIG. 17c), 10° (FIG. 17d), 12° (FIG. 17e) and 14° (FIG. 17f). As shown in FIGS. 17a-f, upon increment of the impinging angle, θ, the local maxima and the right edge of the stopband of the reflectivity spectrum shift towards higher photon energies. The relative position of E₀ with respect to local maxima and minima of the reflectivity spectrum changes with the change of θ, and the reflectivity at the given photon energy oscillates.

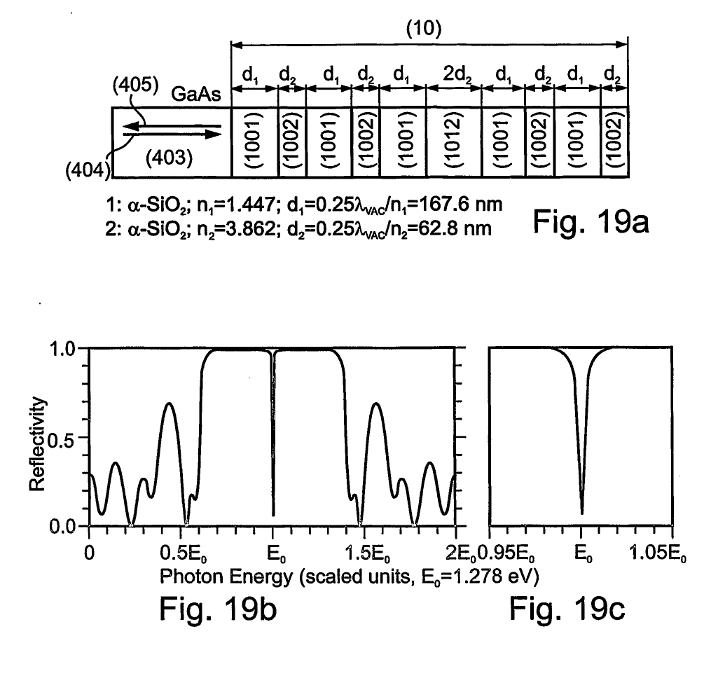

FIG. 18a-b show the angle-dependent reflectivity function of selective reflector 10 with four periods 770 in the embodiment in which four periods 770 comprise thicker layers. As the angle θ increases from 0 to 9.5°, the reflectivity function decreases and reaches a local minimum approximately at θ=9.5°. From θ=9.5° to θ=13°, the reflectivity function increases, and exhibits a local maximum at θ=13°. A second, narrower, local minimum is observed at about θ=15°.

Thus, selective reflector 10 is capable of effectively suppressing high-order modes of waveguide 403.

### Example 4

### Multi-Period Configuration

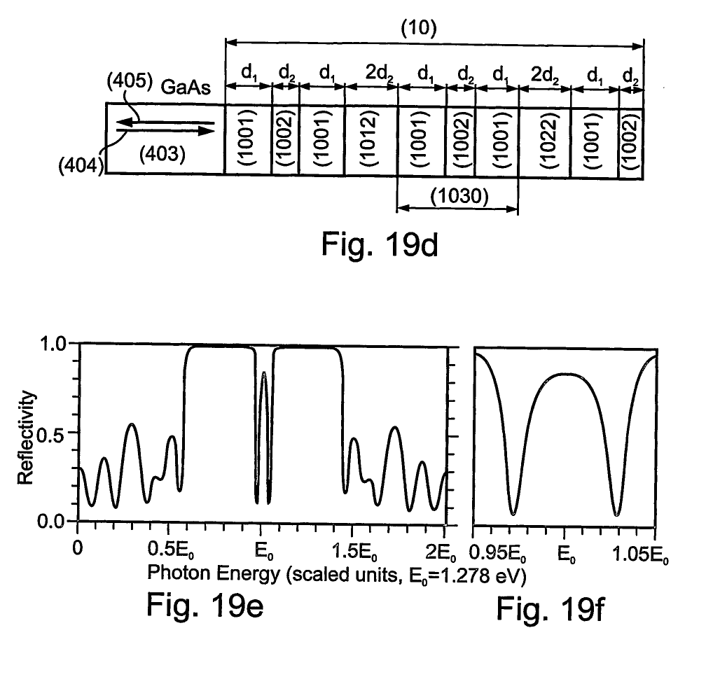

Reference is now made to FIG. 19a which is a schematic illustration of selective reflector 10 having a plurality of layers arranged in a periodic arrangement. According to a preferred embodiment of the present invention selective reflector 10 comprises an alternating sequence of layers 1001 and 1002, having thicknesses d₁ and d₂, of about 0.25λ_{vac}/n₁ and about 0.25λ_{vac}/n₂, respectively. An addition layer 1012, serving as cavity is preferably interposed within the alternating sequence.

Layer 1012 preferably has a larger thickness. In one embodiment, the thickness of layer 1012 is about 2d₂. A skilled artisan would appreciate that the present preferred embodiment of the invention can be considered as two distributed Bragg reflectors and a cavity interposed therebetween. This embodiment is particularly useful when selective reflector 10 is used with a surface emitting laser (e.g., VCSEL).

Similarly to layers 401 and 402, above, layers 1001 and 1002 are preferably formed of materials having different refractive indices, such that layer 1001 is formed of a material having a refractive index, which is different from refractive index of waveguide 403. Layer 1012 and layers 1002 are preferably formed of the same material, hence having similar or identical refractive indices. Representative examples for suitable materials include, without limitation, a-SiO₂, a-Si, a-LiF and a-Si₃N₄.

FIGS. 19b-c show the reflectivity spectrum of selective reflector 10, for θ=0°, in an embodiment in which layer 1001 is formed of amorphous dielectrics a-SiO₂, and layers 1002 and 1012 are formed of amorphous dielectrics a-Si. As shown in FIG. 19b, the reflectivity spectrum has a typical behavior of a reflectivity spectrum of a VCSEL. More specifically, the reflectivity spectrum has a narrow dip in the middle of a wide stopband.

Reference is now made to FIG. 19d which is a schematic illustration of selective reflector 10 having a plurality of layers arranged in a periodic arrangement and two cavities. In this embodiment, selective reflector 10 further comprises an additional layer 1022 preferably formed of the same material as the layer 1002 and having a thickness 2d₂. Layer 1022 serves as an additional cavity. The first cavity 1012 and second cavity 1022 are connected by an optical tunnel region 1030. In the particular embodiment of FIG. 19d, optical tunnel region 1030 comprises a first layer 1001, a layer 1002 and a second layer 1001.

FIGS. 19e-f show the corresponding reflectivity spectrum, for θ=0°. Electromagnetic interaction between the cavities (layers 1012 and 1022) results in a formation of two dips (as opposed to the single dip shown in FIGS. 19b-c). As shown in FIGS. 19e-f, a narrow local maximum in the reflectivity spectrum is located between the two dips.

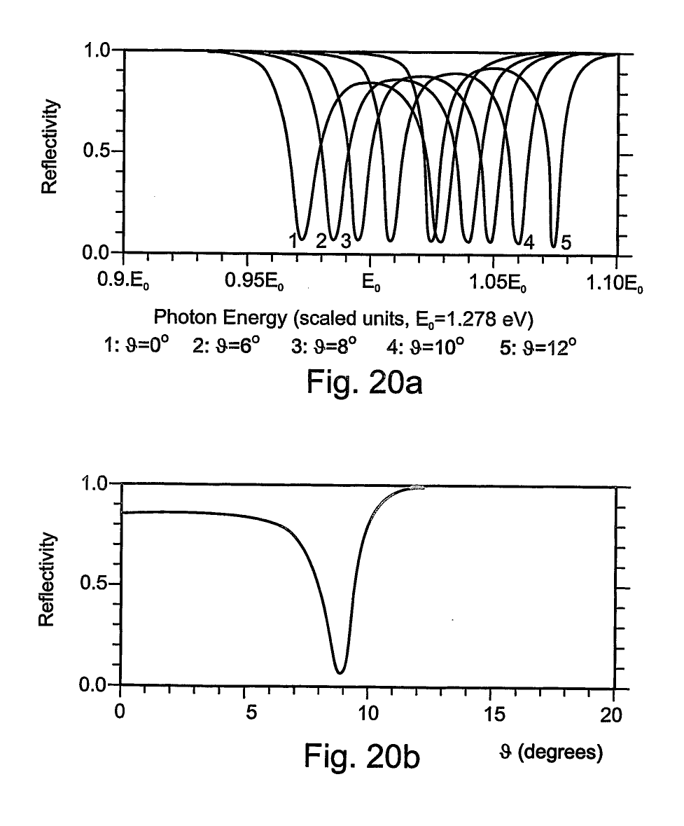

FIG. 20a shows reflectivity spectra of selective reflector 10 with a plurality of layers arranged in a periodic arrangement and two cavities (see FIG. 19d). Shown in FIG. 20a are five curves, designated 1-5 and respectively corresponding to the following values of θ: 0°, 6°, 8°, 10° and 12°. The edges of the stopband, the two dips and the local maximum between the dips shift towards higher photon energies, with increment of the impinging angle. The relative position of E₀ changes from the local maximum in the reflectivity to the left dip, and then falls off to the left of the stopband.

FIG. 20b shows the corresponding angle-dependent reflectivity function for E=E₀. As the angle changes from 0 to 9°, the reflectivity function decreases first mildly, and then more rapidly, reaching a local minimum approximately at 9°. For larger angles, the reflectivity function exhibits a monotonic increment.

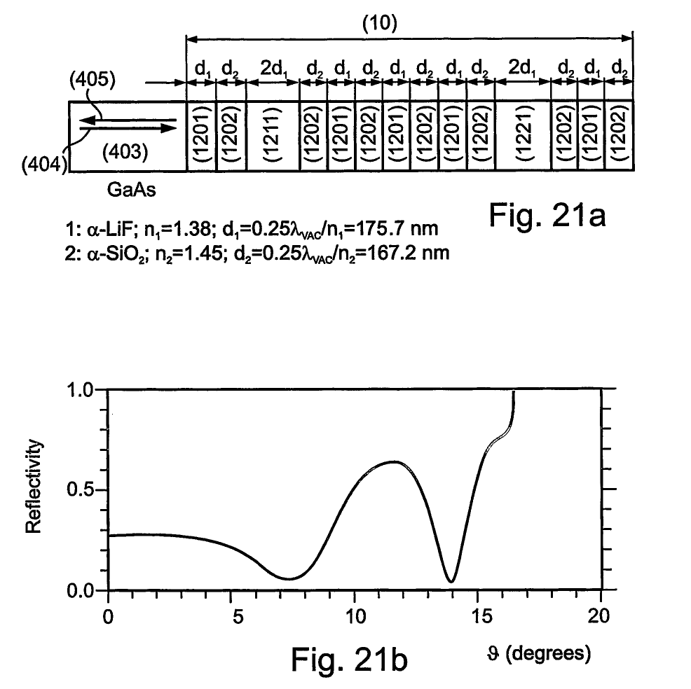

FIG. 21a is a schematic illustration of selective reflector 10 with two cavities in an embodiment in which seven layers separate the two cavities (as opposed to three separating layers shown in FIG. 19d). Hence, according to a preferred embodiment of the present invention selective reflector 10 comprises a set of alternating layers 1201 and 1202, and two additional layers 1211 and 1212 serving as cavities, as further detailed hereinabove. Similarly to layers 1001 and 1002 above, the thicknesses of layers 1201 and 1202 are preferably d₁=0.25λ_{vac}/n₁ and d₂=0.25λ_{vac}/n₂. Layers 1201, 1211 and 1212 are preferably made of the same material hence having similar or identical refractive indices. The thicknesses of layers 1211 and 1212 are preferably 2d₂. Similar to the above, layers 1201 and 1202 are preferably formed of materials having different refractive indices, such that layer 1201 is formed of a material having a refractive index different from the refractive index of waveguide 403. Representative examples for suitable materials include, without limitation, a-SiO₂, a-Si, a-LiF and a-Si₃N₄.

According to a preferred embodiment of the present invention the difference in the refractive indices of layers 1201 and 1202 is substantially small. In one embodiment, layers 1201, 1211, and 1221 are formed of a-LiF with a refractive index n₁=1.38, and layer 1202 is formed of a-SiO₂ with a refractive index n₂=1.45.

FIG. 21b shows the corresponding angle-dependent reflectivity function for E=E₀. As the angle changes from 0 to 7.5° the reflectivity function decreases and reaches its first local minimum approximately at 7.5°.

### Example 5

### A Bragg Reflector and an Amorphous Dielectric Selective Reflector

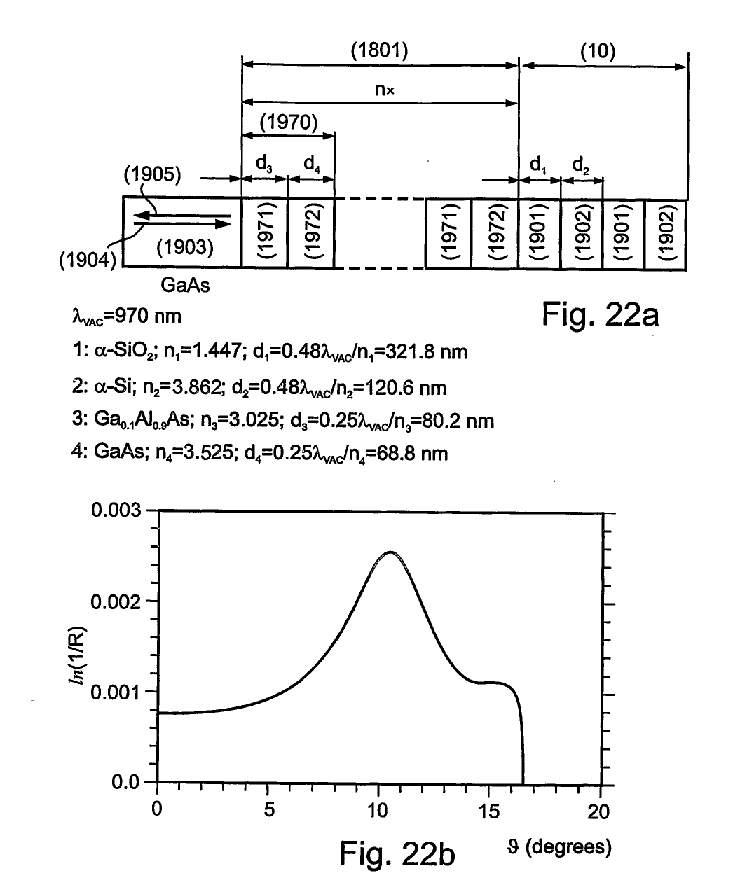

FIG. 22a schematically illustrates a particular example configuration of Bragg reflector 1801 and selective reflector 10 which can be used in combination with apparatus 1700. Hence, according to a preferred embodiment of the present invention Bragg reflector 1801 comprises n periods 1970, each comprises a first layer 1971 and a second layer 1972. Layers 1971 and 1972 are preferably designed as typical layers in a semiconductor distributed Bragg reflector.

For example, for a wavelength of λ_{vac}=970 nm, layer 1971 is formed of Ga_{0.1}Al_{0.9}As, with a refractive index n₃=3.025, and layer 1972 is formed of GaAs, with a refractive index n₄=3.525. According to a preferred embodiment of the present invention the thicknesses of layers 1971 and 1972 are, respectively, about 0.25λ_{vac}/n₃, and about 0.25λ_{vac}/n₄. The number of periods 1970 is preferably n>20. As an example, n=25 is assumed.

Selective reflector 10 preferably comprises two pairs of layers, designated in FIG. 22a by numerals 1901 and 1902. Layer 1901 is preferably formed of a-SiO₂, with refractive index n₁=1.447, and layer 1902 is preferably formed of a-Si, with refractive index n₂=3.862. According to a preferred embodiment of the present invention the thicknesses of layers 1901 and 1902 are, respectively, about 0.48λ_{vac}/n₂, and about 0.48λ_{vac}/n₂. In use light 1904 exits from cavity 1704, impinges on Bragg reflector 1801 and reflects back to cavity 1704. The reflected light is designated in FIG. 22a by numeral 1905.

FIG. 22b is a plot of ln(1/R) as a function θ for the example configuration of Bragg reflector 1801 and selective reflector 10 shown in FIG. 22a. In FIG. 22b, R is the angle-dependent reflectivity function and θ is the impinging angle of light 1904 on Bragg reflector 1801. The selection of the quantity ln(1/R) to present the angle-dependent reflectivity function is purely a matter of convenience because the reflectivity of a distributed Bragg reflector is typically very close to unity.

As shown in FIG. 22b, the quantity ln(1/R) increases with increment of θ from 0 to approximately 10.5°. One of ordinary skill in the art will appreciate that an increment of ln(1/R) is equivalent to a decrement of R. Bragg reflector 1801 and selective reflector 10, therefore, successfully provides increment of external optical losses when the impinging angle increases. Such increment of external optical losses ensures a high reflectivity for small impinging angles and low reflectivity for large impinging angle. The optical losses reach the maximum value at approximately 10.5°, and further decrease and vanish at the angle of the total internal reflection 16.5°.

Thus, the present embodiment can be used to provide a single-mode or a few-modes lasing of surface emitting laser apparatus 1700, in particular when apparatus 1700 includes an extended optical aperture (e.g., wider than 5 μm).

### Example 6

### A Bragg Reflector and a Crystalline Semiconductor Selective Reflector

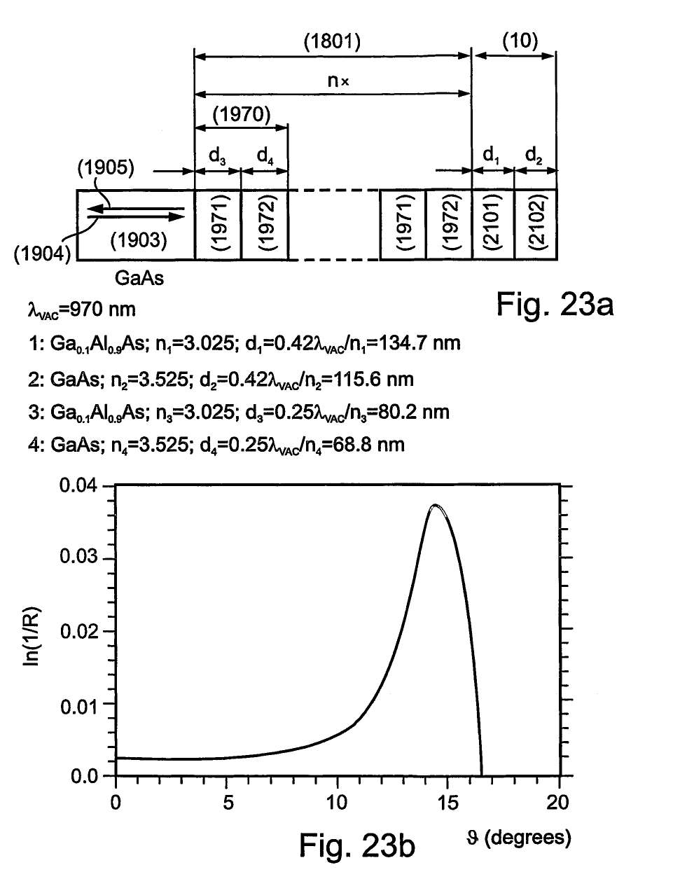

FIG. 23a schematically illustrates a particular example configuration of Bragg reflector 1801 and selective reflector 10 in an embodiment in which selective reflector 10 is formed of crystalline semiconductor materials. This embodiment can be used, as stated, in combination with apparatus 1700. Hence, according to a preferred embodiment of the present invention, Bragg reflector 1801 comprises n=24 periods of alternating Ga_{0.1}Al_{0.9}As and GaAs, and selective reflector 10 comprises a first layer 2101 formed of Ga_{0.1}Al_{0.9}As and a second layer 2102 formed of GaAs. Preferably, the thicknesses of layers 2101 and 2102 are, about 0.42λ_{vac}/n₁ and about 0.42λ_{vac}/n₂, respectively.

FIG. 23b shows is a plot of ln(1/R) as a function θ for the example configuration of Bragg reflector 1801 and selective reflector 10 shown in FIG. 23a. As shown in FIG. 23b, the quantity ln(1/R) increases as the angle θ inreases from 0 to approximately 15°, where a local maximum is observed. Bragg reflector 1801 and selective reflector 10, therefore, successfully provides increment of external optical losses when the impinging angle increases. Such increment of external optical losses ensures a high reflectivity for small impinging angles and low reflectivity for large impinging angle. The optical losses further decrease and vanish at the angle of the total internal reflection 16.5°.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A selective reflector for selectively preventing reflection of light passing therethrough, the selective reflector comprising at least one layer characterized by an angle-dependent reflectivity function, said angle-dependent reflectivity function being decreasing upon at least one interval of increasing impinging angle of the light on a surface of said at least one layer, such that when said impinging angle is within a predetermined range, the reflection of light is substantially prevented.

2. The selective reflector of claim 1, wherein said angle-dependent reflectivity function comprises at least one local minimum, corresponding to said predetermined range of said impinging angle.

3. The selective reflector of claim 1, wherein each of said at least one layer is independently made of a material selected from the group consisting of an amorphous dielectric material and a crystalline semiconductor material.

4. The selective reflector of claim 1, wherein said at least one layer comprises two layers.

5. The selective reflector of claim 1, wherein said at least one layer comprises plurality of layers.

6. (canceled)

7. The selective reflector of claim 1, wherein the light is a coherent light.

8-33. (canceled)

34. The selective reflector of claim 1, wherein said predetermined range of said impinging angle is from about 2 degrees to about 12 degrees.

35. The selective reflector of claim 1, wherein said predetermined range of said impinging angle is from about 3 degrees to about 10 degrees.

36. An apparatus for providing a laser radiation, the apparatus comprising:
(a) a light-emitting device having an extended waveguide and an active region capable of generating light when exposed to an injection current; and
(b) a feedback device for providing a feedback for generating a laser light, said feedback device comprising a selective reflector having at least one layer characterized by an angle-dependent reflectivity function;
said angle-dependent reflectivity function being decreasing upon at least one interval, such that a reflection of said light is high for small impinging angles and low for large impinging angles of said light on a surface of said selective reflector.

37. The apparatus of claim ______, wherein said active region is designed and constructed to emit said light through a surface of said active region.

38. The apparatus of claim 36, wherein said active region is designed and constructed to emit said light through an edge of said active region.

39. The apparatus of claim 36, being capable of emitting said laser in a single transverse optical mode.

40. The apparatus of claim 36, being capable of emitting said laser in a single lateral optical mode.

41. The apparatus of claim 36, being capable of generating a non-coherent light solely by said injection current and said laser light is generated by a combination of said injection current and said feedback.

42. The apparatus of claim 36, further comprising an external cavity designed such that said laser light is generated substantially in a fundamental transverse mode.

43. The apparatus of claim 36, wherein said small impinging angles are substantially smaller than a characteristic total internal reflection angle, calculated with respect to said extended waveguide and an ambient medium.

44. The apparatus of claim 36, wherein said small impinging angles are from zero to about 8 degrees.

45. (canceled)

46. The apparatus of claim 36, wherein said small impinging angles are from zero to about 6 degrees.

47. (canceled)

48. The apparatus of claim 36, wherein said small impinging angles are from zero to about 4 degrees.

49. (canceled)

50. The apparatus of claim 36, wherein said small impinging angles are from zero to about 2 degrees.

51. (canceled)

52. The apparatus of claim 36, wherein said light-emitting device comprises an n-emitter, adjacent to said extended waveguide from a first side and a p-emitter adjacent to said extended waveguide from a second side.

53-55. (canceled)

56. The apparatus of claim 36, wherein said light-emitting device comprises an n-contact being in contact with said substrate and a p-contact being in contact with said p-emitter.

57-91. (canceled)

92. The apparatus of claim 36, wherein said angle-dependent reflectivity function comprises at least one local minimum, corresponding to said predetermined range of said impinging angle.

93. The apparatus of claim 36, wherein each of said at least one layer of said selective reflector is independently made of a material selected from the group consisting of an amorphous dielectric material and a crystalline semiconductor material.

94. The apparatus of claim 36, wherein said at least one layer of said selective reflector comprises two layers.

95. The apparatus of claim 36, wherein said at least one layer of said selective reflector comprises plurality of layers.

96. (canceled)

97. The apparatus of claim 36, wherein said extended waveguide has a width of at least 5 micrometers.

98-115. (canceled)

116. An apparatus for providing a laser radiation, the apparatus comprising:
(a) a distributed Bragg reflector;
(b) a cavity having therein an active region having a surface and capable of emitting light, through said surface, when exposed to an injection current; and
(c) a feedback device for providing a feedback for generating a laser light, said feedback device comprising a selective reflector having at least one layer characterized by an angle-dependent reflectivity function;
said angle-dependent reflectivity function being decreasing upon at least one interval, such that a reflection of said light is high for small impinging angles and low for large impinging angles of said light on a surface of said selective reflector.

117. The apparatus of claim 116, further comprising an n-current spreading layer and a p-current spreading layer positioned such that said active region is interposed therebetween.

118-122. (canceled)

123. The apparatus of claim 116, further comprising an additional distributed Bragg reflector, positioned between said cavity and said feedback device.

124. The apparatus of claim 116, wherein said angle-dependent reflectivity function comprises at least one local minimum, corresponding to said predetermined range of said impinging angle.

125. The apparatus of claim 116, wherein each of said at least one layer of said selective reflector is independently made of a material selected from the group consisting of an amorphous dielectric material and a crystalline semiconductor material.

126. The apparatus of claim 116, wherein said at least one layer of said selective reflector comprises two layers.

127. The apparatus of claim 116, wherein said at least one layer of said selective reflector comprises plurality of layers.

128. (canceled)

129. The apparatus of claim 116, wherein said cavity has a lateral dimension of at least 5 micrometers.

130-147. (canceled)

148. An apparatus for providing a laser radiation, the apparatus comprising:
(a) a first distributed Bragg reflector;
(b) a cavity having therein an active region having a surface and capable of emitting light, through said surface, when exposed to an injection current;
(c) a second distributed Bragg reflector; and
(c) a selective reflector having at least one layer characterized by an angle-dependent reflectivity function;
said angle-dependent reflectivity function being decreasing upon at least one interval of increasing impinging angle of said light on a surface of said selective reflector, such that a reflection of said light is high for small impinging angles and low for large impinging angles.

149. The apparatus of claim 148, further comprising an n-current spreading layer and a p-current spreading layer positioned such that said active region is interposed therebetween.

150-154. (canceled)

155. The apparatus of claim 148, wherein said angle-dependent reflectivity function comprises at least one local minimum, corresponding to said predetermined range of said impinging angle.

156. The apparatus of claim 148, wherein each of said at least one layer of said selective reflector is independently made of a material selected from the group consisting of an amorphous dielectric material and a crystalline semiconductor material.

157. The apparatus of claim 148, wherein said at least one layer of said selective reflector comprises two layers.

158. The apparatus of claim 148, wherein said at least one layer of said selective reflector comprises plurality of layers.

159. (canceled)

160. The apparatus of claim 148, wherein said cavity has a lateral dimension of at least 5 micrometers.

161-178. (canceled)

179. An apparatus for providing a laser radiation, the apparatus comprising:
a cavity having therein an active region having a surface and capable of emitting light, through said surface, when exposed to an injection current;
said cavity being interposed between a first feedback device and a second feedback device, each of said first and second feedback devices being capable of providing a feedback for generating a laser light, and comprising a selective reflector having at least one layer characterized by an angle-dependent reflectivity function;
said angle-dependent reflectivity function being decreasing upon at least one interval of increasing impinging angle of said light on a surface of said selective reflector, such that a reflection of said light is high for small impinging angles and low for large impinging angles.

180. The apparatus of claim 179, further comprising an n-current spreading layer and a p-current spreading layer positioned such that said active region is interposed therebetween.

181-185. (canceled)

186. The apparatus of claim 179, wherein said first feedback device comprises a Bragg reflector.

187. The apparatus of claim 179, wherein said second feedback device comprises a Bragg reflector.

188. The apparatus of claim 179, wherein said angle-dependent reflectivity function comprises at least one local minimum, corresponding to said predetermined range of said impinging angle.

189. The apparatus of claim 179, wherein each of said at least one layer of said selective reflector is independently made of a material selected from the group consisting of an amorphous dielectric material and a crystalline semiconductor material.

190. The apparatus of claim 179, wherein said at least one layer of said selective reflector comprises plurality of layers.

191. (canceled)

192. The apparatus of claim 179, wherein said cavity has a lateral dimension of at least 5 micrometers.

193-209. (canceled)

210. A method of improving a quality of a laser beam, the laser beam being generated by an injection current and a feedback light, the method comprising passing the feedback light through a selective reflector and using said selective reflector for allowing reflection of said feedback light for small impinging angles and preventing reflection of said feedback light for large impinging angles of said feedback light on a surface of said selective reflector.

211. The method of claim 210, wherein the laser beam is produced by a laser apparatus having an extended waveguide.

212. (canceled)

213. The method of claim 210, wherein said selective reflector comprises at least one layer characterized by an angle-dependent reflectivity function, said angle-dependent reflectivity function being decreasing upon at least one interval of increasing impinging angle.

214-236. (canceled)

237. The method of claim 210, wherein said predetermined range of said impinging angle is from about 3 degrees to about 12 degrees.

238. The method of claim 210, wherein said predetermined range of said impinging angle is from about 3 degrees to about 10 degrees.
